(19) United States
(12) Patent Application Publication
(10) Pub. No.: US 2025/0342599 A1
(43) Pub. Date: Nov. 6, 2025

(54) IMAGE PROCESSING APPARATUS AND IMAGE PROCESSING METHOD

(71) Applicant: CANON KABUSHIKI KAISHA, Tokyo (JP)

(72) Inventors: KATSUHIRO ITO, Kanagawa (JP); AKIHIRO TSUBUSAKI, Kanagawa (JP)

(21) Appl. No.: 19/185,741

(22) Filed: Apr. 22, 2025

(30) Foreign Application Priority Data
May 1, 2024 (JP) 2024-074511
Nov. 13, 2024 (JP) 2024-198333

(51) Int. Cl. G06T 7/215; G06T 7/80

(52) U.S. Cl. CPC G06T 7/215; G06T 7/80

(57) ABSTRACT

Disclosed is an image processing apparatus that detects one or more motion vectors from a moving image and obtains information about a subject region detected in the moving image and information about movement of an image capture apparatus occurring when the moving image was captured. The apparatus identifies camerawork of the image capture apparatus performed when the moving image was captured, from among a predetermined plurality of types of camerawork, based on at least two of the one or more motion vectors, the information about the subject region, and the information about movement.

### BACKGROUND OF THE INVENTION

### Field of the Invention

The present invention relates to an image processing apparatus and an image processing method.

### Description of the Related Art

Identifying camerawork performed when capturing a moving image (methods for moving a camera and capturing techniques) is useful for appropriately processing the captured moving image, for example. A method for identifying specific camerawork based on a distribution of motion vectors in an image is known (Japanese Patent Laid-Open No. 2006-344131).

With the past technique disclosed in Japanese Patent Laid-Open No. 2006-344131, camerawork is identified based on the frequency and shape of the distribution of motion vectors. As a result, the identification has been limited to rough camerawork, such as pan, zoom, tracking, and the like.

### SUMMARY OF THE INVENTION

Some embodiments of the present invention provide an image processing apparatus and an image processing method capable of determining camerawork in more detail by using a plurality of items of information.

According to an aspect of the present invention, there is provided an image processing apparatus comprising: one or more processors that execute a program stored in a memory and thereby function as: a detection unit configured to detect one or more motion vectors from a moving image; a first obtainment unit configured to obtain information about a subject region detected in the moving image; a second obtainment unit configured to obtain information about movement of an image capture apparatus occurring when the moving image was captured; and an identification unit configured to, based on at least two of the one or more motion vectors, the information about the subject region, and the information about movement, identify camerawork of the image capture apparatus performed when the moving image was captured, from among a predetermined plurality of types of camerawork.

According to another aspect of the present invention, there is provided an image capture apparatus comprising: an image capture circuitry that outputs a moving image; an image processing apparatus that identifies camerawork of the image capture apparatus performed when the moving image was captured; and a recording circuitry that records a type of the camerawork identified by the identification unit in association with the moving image, wherein the image processing apparatus comprises: one or more processors that execute a program stored in a memory and thereby function as: a detection unit configured to detect one or more motion vectors from the moving image; a first obtainment unit configured to obtain information about a subject region detected in the moving image; a second obtainment unit configured to obtain information about movement of the image capture apparatus occurring when the moving image was captured; and an identification unit configured to, based on at least two of the one or more motion vectors, the information about the subject region, and the information about movement, identify the camerawork of the image capture apparatus performed when the moving image was captured, from among a predetermined plurality of types of camerawork.

According to a further aspect of the present invention, there is provided an image processing method comprising: detecting a motion vector from a moving image; obtaining information about a subject region detected in the moving image; obtaining information about movement of an image capture apparatus occurring when the moving image was captured; and based on at least two of the motion vector, the information about the subject region, and the information about movement, identifying camerawork of the image capture apparatus performed when the moving image was captured, from among a predetermined plurality of types of camerawork.

According to another aspect of the present invention, there is provided a non-transitory computer-readable medium storing a program for causing a computer to perform an image processing method comprising: detecting a motion vector from a moving image; obtaining information about a subject region detected in the moving image; obtaining information about movement of an image capture apparatus occurring when the moving image was captured; and based on at least two of the motion vector, the information about the subject region, and the information about movement, identifying camerawork of the image capture apparatus performed when the moving image was captured, from among a predetermined plurality of types of camerawork.

Further features of the present invention will become apparent from the following description of exemplary embodiments (with reference to the attached drawings).

### BRIEF DESCRIPTION OF THE DRAWINGS

FIG. 1 is a block diagram illustrating an example of the functional configuration of a digital camera according to a first embodiment.

FIG. 2 is a diagram illustrating an example of the configuration of a moving image file generated by the digital camera according to the first embodiment.

FIG. 3 is a block diagram illustrating an example of the functional configuration of a capturing information generation unit according to the first embodiment.

FIG. 4 is a flowchart pertaining to operations by a camerawork identification unit according to the first embodiment.

FIG. 5 is a schematic diagram illustrating horizontal movement of the camera and a motion vector detected.

FIG. 6 is a schematic diagram illustrating forward movement of the camera and a motion vector detected.

FIG. 7 is a flowchart illustrating details of step S402 of FIG. 4.

FIGS. 8A and 8B are flowcharts illustrating details of step S702 of FIG. 7.

FIG. 9 is a diagram illustrating processing performed in step S702 of FIG. 7.

FIG. 10 is a diagram illustrating processing performed in step S702 of FIG. 7.

FIG. 11 is a diagram illustrating processing performed in step S702 of FIG. 7.

FIG. 12 is a diagram illustrating an example of estimating a movement direction according to the first embodiment.

FIG. 13 is a flowchart illustrating details of step S405 of FIG. 4.

FIGS. 14A and 14B are flowcharts illustrating details of step S1302 of FIG. 13.

FIG. 15 is a flowchart illustrating details of step S1304 of FIG. 13.

FIGS. 16A and 16B are flowcharts illustrating details of step S1306 of FIG. 13.

FIG. 17 is a diagram illustrating a list of camerawork that can be identified according to the first embodiment.

FIGS. 18A and 18B are diagrams illustrating an example of the external appearance of a gimbal camera according to a second embodiment.

FIG. 19 is a block diagram illustrating an example of the functional configuration of the gimbal camera according to the second embodiment.

FIGS. 20A and 20B are diagrams illustrating erroneous identification in capturing while walking.

FIG. 21A is a diagram illustrating a change over time in a gimbal control amount in capturing while walking.

FIG. 21B is a schematic diagram illustrating the gimbal camera when capturing while walking.

FIG. 22 is a flowchart pertaining to camerawork identification processing according to the second embodiment.

FIGS. 23A and 23B are diagrams illustrating a third embodiment.

FIG. 24 is a flowchart pertaining to camera movement direction determination processing according to the third embodiment.

FIG. 25 is a diagram illustrating an angle of a motion vector according to the third embodiment.

FIGS. 26A to 26C are diagrams illustrating an example of an angle histogram of motion vectors.

FIG. 27 is a flowchart illustrating details of step S2404 of FIG. 24.

FIG. 28 is a flowchart illustrating details of step S2405 of FIG. 24.

FIG. 29 is a flowchart illustrating details of step S2801 of FIG. 28.

FIGS. 30A and 30B are flowcharts illustrating details of step S2802 of FIG. 28.

FIG. 31 is a schematic diagram illustrating a partial region of a motion vector according to the third embodiment.

FIG. 32 is a schematic diagram illustrating a motion vector detected from a moving subject.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Note that the following will describe embodiments in which the present invention is applied in a digital camera serving as an example of an image processing apparatus. However, an image capture function is not essential to the present invention, and the present invention can be implemented in any electronic device having at least one computation circuit or processor. Examples of such an electronic device include video cameras, computer devices (personal computers, tablet computers, media players, PDAs, and the like), smartphones, smart watches, game consoles, robots, drones, and dashboard cameras. These are merely examples, however, and the present invention can be applied in other electronic devices as well.

### First Embodiment

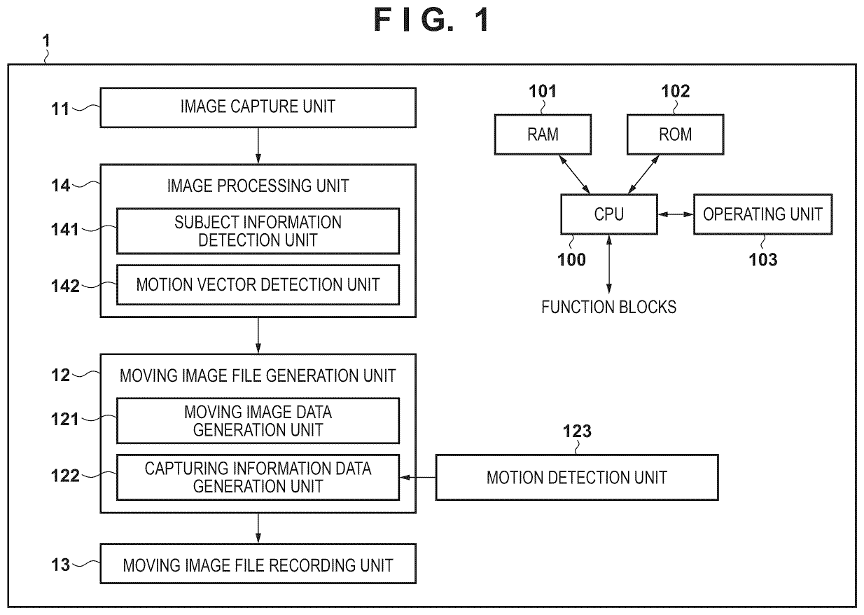

FIG. 1 is a block diagram illustrating an example of the functional configuration of a digital camera 1, serving as an example of an image processing apparatus according to an embodiment, pertaining to the recording of moving images, along with a flow of processing. Aside from parts that can clearly only be implemented by hardware (e.g., an optical lens, an image sensor, and the like), the function blocks in the digital camera 1 can be implemented by software, or by a combination of software and hardware. For example, the function blocks may be implemented by dedicated hardware such as ASICs. Alternatively, the function blocks may be implemented by a processor such as a CPU executing programs stored in the memory. Note also that multiple function blocks may be implemented by a shared configuration (e.g., a single ASIC). Furthermore, hardware implementing some functions of a given function block may be included in hardware implementing another function block.

One or more processor 100 (simply “CPU” hereinafter) is a control unit for the digital camera 1. The CPU 100 implements the functions of the digital camera 1 by loading programs stored in a ROM 102 into a RAM 101 and executing the programs to control the operations of the respective function blocks, for example.

The ROM 102 is, for example, rewritable non-volatile memory, and stores programs which can be executed by the CPU 100, setting values, GUI data, and the like. The RAM 101 is used to load programs executed by the CPU 100, store values required while programs are being executed, and the like. Part of the RAM 101 may also be used as video memory for storing display image data.

“Operating unit 103” is a collective name for input devices (buttons, switches, dials, and the like) provided for a user to input various types of instructions to the digital camera 1. The input devices constituting the operating unit 103 are named according to the functions assigned thereto. For example, the operating unit 103 includes a release switch, a moving image recording switch, a capturing mode selection dial for selecting a capturing mode, a menu button, a directional key, an OK key, and the like.

The release switch is a switch for recording still images, and the CPU 100 recognizes a half-pressed state of the release switch as a capture preparation instruction and a fully-pressed state of the release switch as a capture start instruction. In addition, the CPU 100 recognizes a moving image recording switch being pressed in a capture standby state as a moving image recording start instruction, and recognizes the moving image recording switch being pressed during the recording of a moving image as a recording stop instruction. Note that the functions assigned to the same input device may be variable. Additionally, the input devices may include software buttons or keys which use a touchscreen.

An image capture unit 11 includes an optical lens that generates an optical image of a subject, and an image sensor that converts the optical image into an image signal. The image capture unit 11 may further include a mechanical shutter, an aperture stop, and the like. The image sensor may be a publicly-known CCD or CMOS color image sensor having, for example, a primary color Bayer array color filter. The image sensor includes a pixel array, in which a plurality of pixels are arranged two-dimensionally, and peripheral circuitry for reading out signals from the pixels. Each pixel accumulates a charge corresponding to an amount of incident light through photoelectric conversion. By reading out, from each pixel, a signal having a voltage corresponding to the charge amount accumulated during an exposure period, a group of pixel signals (analog image signals) representing an optical image formed on the image capturing surface is obtained. The operations of the image capture unit 11 are controlled by the CPU 100.

It is assumed hereinafter that the image capture unit 11 outputs a moving image signal having a predetermined framerate, but the image capture unit 11 can also output a still image signal. If the image sensor has an A/D conversion function, the image capture unit 11 outputs a digital moving image signal (moving image data).

The image signal output by the image capture unit 11 is supplied to an image processing unit 14. The image processing unit 14 generates signals and image data for different purposes, obtains and/or generates various types of information, and the like by applying predetermined image processing such as A/D conversion and the like to the image signal output by the image capture unit 11. The operations of the image processing unit 14 are controlled by the CPU 100.

The image processing unit 14 may be a dedicated hardware circuit, such as an Application Specific Integrated Circuit (ASIC) designed to implement a specific function, for example. Alternatively, the image processing unit 14 may be constituted by a processor such as a Digital Signal Processor (DSP) or a Graphics Processing Unit (GPU) executing software to implement a specific function. The image processing unit 14 outputs the obtained or generated information, data, and the like to the CPU 100, the RAM 101, or the like, according to the purpose of use.

The image processing applied by the image processing unit 14 includes pre-processing, color interpolation processing, correction processing, detection processing, data processing, evaluation value calculation processing, special effect processing, and the like, for example. For the sake of simplicity, of the various types of image processing applied by the image processing unit 14, FIG. 1 illustrates particularly the detection of subject information and the detection of motion vectors, which are part of the detection processing, as being executed by individual function blocks 141 and 142.

A subject information detection unit 141 detects, as a subject region, an image region in which a subject of a predetermined type is thought to appear. For each detected subject region, the subject information detection unit 141 outputs a position and a size within the image, a confidence of the detection, and the like as a detection result. The subject information detection unit 141 can detect the subject region using any publicly-known method using pattern matching, a machine learning model, or the like. The type of the subject detected by the subject information detection unit 141 is not particularly limited, and the detection is implemented for various types of subjects, such as the faces or overall bodies of people and animals, vehicles, and the like.

A motion vector detection unit 142 detects a motion vector between frames based on a current frame and a past frame (e.g., a most recent frame). The motion vector detection unit 142 detects a motion vector for each of regions obtained by dividing the entirety of a past frame into a plurality of parts in the horizontal and vertical directions. The motion vector detection unit 142 also detects a motion vector for each subject region detected in the past frame. The motion vector detection unit 142 can detect the motion vector using any publicly-known method. To give one example, a motion vector of a template can be detected by performing template matching on a current frame using a region of a past frame as a template. Specifically, the motion vector detection unit 142 can detect, as a motion vector, a vector which starts at coordinates of the template and ends at the coordinates of the region in the current frame having the highest correlation with the template. The coordinates may be image coordinates of the center or the center of gravity of the region, for example. The motion vector detection unit 142 stores the motion vector detection result in the RAM 101.

The image processing unit 14 outputs the image data of the current frame to which the image processing has been applied to a moving image file generation unit 12. Although FIG. 1 illustrates the moving image file generation unit 12 as a separate function block from the image processing unit 14 for the sake of simplicity, the image processing unit 14 may include the moving image file generation unit 12.

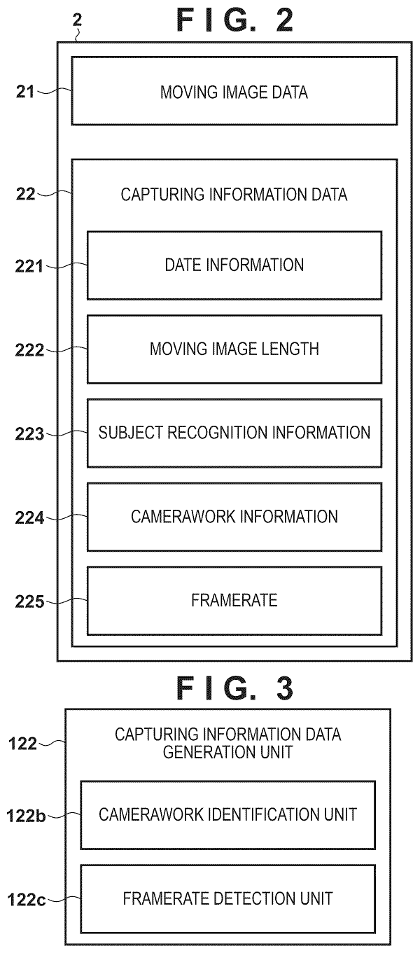

The moving image file generation unit 12 generates a moving image file 2 having a data structure such as that illustrated in FIG. 2, for example. The moving image file 2 at least stores moving image data 21 and capturing information data 22. Note that the moving image data 21 and the capturing information data 22 may be stored in the moving image file 2 in an arrangement that is the reverse of the arrangement illustrated in FIG. 2. In reality, the moving image data 21 and the capturing information data 22 are stored in the moving image file 2 in an arrangement according to the moving image file format used by the digital camera 1.

Like the image processing unit 14, the moving image file generation unit 12 may be dedicated hardware circuitry, or may be implemented by a processor executing a program stored in a memory to implement specific functions. A moving image data generation unit 121 and a capturing information data generation unit 122 indicate parts of the functions of the moving image file generation unit 12 as function blocks. Accordingly, operations performed by the moving image data generation unit 121 and the capturing information data generation unit 122 are actually executed by the moving image file generation unit 12.

The moving image data generation unit 121 generates moving image data based on the image data supplied from the image processing unit 14. The moving image data generation unit 121 applies necessary processing such as encoding to the image data, and generates moving image data in a format set in the digital camera 1, for example. The moving image data generation unit 121 stores the generated moving image data in the RAM 101.

The capturing information data generation unit 122 generates the capturing information data 22. In the example illustrated in FIG. 2, the capturing information data 22 includes date information 221, a moving image length 222, subject recognition information 223, camerawork information 224, and a framerate 225. However, the number and types of information included in the capturing information data 22 are not limited thereto. The operations of the capturing information data generation unit 122 will be described in detail later.

The moving image file generation unit 12 generates data of a moving image file storing the moving image data generated by the moving image data generation unit 121 and the capturing information data generated by the capturing information data generation unit 122, and stores that data in the RAM 101.

A moving image file recording unit 13 records the data of the moving image file generated by the moving image file generation unit 12 to a predetermined recording destination. The recording destination may be a memory card mounted in the digital camera 1, or may be an external recording device such as cloud storage, for example.

A motion detection unit 123 outputs, to the capturing information data generation unit 122, a signal based on movement of the digital camera 1. The motion detection unit 123 may be an accelerometer, an angular velocity sensor, or the like, for example. As one example, the motion detection unit 123 is assumed to be an angular velocity sensor that detects the angular velocity around each axis in a Cartesian coordinate system constituted by three axes, namely an axis orthogonal to the optical axis direction of the digital camera 1 (an x axis), and axes orthogonal to the optical axis direction and extending in the horizontal direction (a y axis) and a vertical direction (a z axis) of the image sensor. The horizontal direction of the image sensor may be a direction parallel to the bottom surface of the digital camera 1, or a direction parallel to a long side of the image sensor.

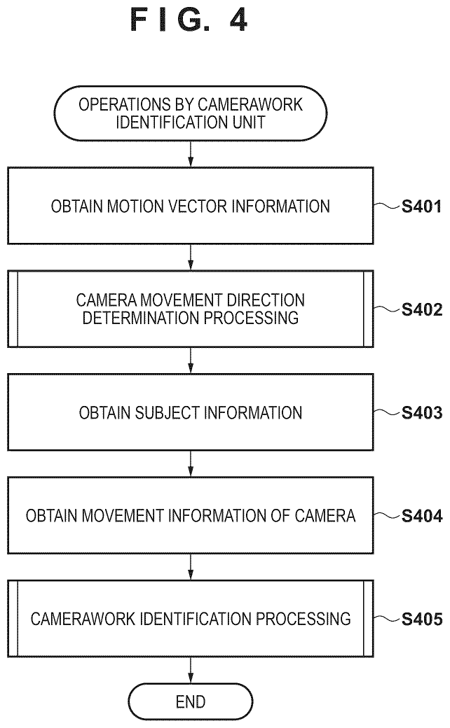

FIG. 3 is a diagram illustrating each of representative functions of the capturing information data generation unit 122 as function blocks. The function blocks of the capturing information data generation unit 122 can be implemented by software, hardware, or a combination thereof in accordance with the form in which the moving image file generation unit 12 is implemented. Note that the capturing information data generation unit 122 can include functions other than those illustrated here.

A camerawork identification unit 122b identifies camerawork performed during the capturing of a moving image, based on at least two of (i) a detection result by the subject information detection unit 141, (ii) a detection result by the motion vector detection unit 142, and (iii) movement of the digital camera 1 detected by the motion detection unit 123. “Camerawork” refers to the type of movement method and capturing technique for the camera used to express an image.

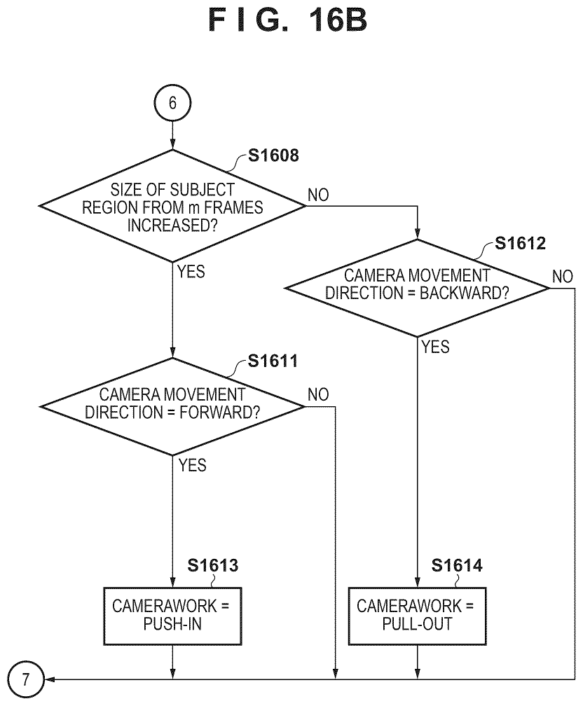

FIG. 17 is a diagram illustrating a list of camerawork that can be identified according to the present embodiment. In FIG. 17, the camera being in a “fixed position” means that the position of the viewpoint of the camera is not moving, but the position of the camera is not limited. Likewise, the subject being in a “fixed position” means that the subject is not moving, but the position of the subject is also not limited. The processing by the camerawork identification unit 122b will be described in detail later.

A framerate detection unit 122c detects the framerate of the moving image data generated by the moving image data generation unit 121. The framerate detection may be executed continuously or periodically while moving image data is being generated. If the framerate of the moving image data generated by the moving image data generation unit 121 is constant, the framerate detection unit 122c may detect the framerate by referring to a setting value stored in the ROM 102 or the RAM 101.

### Operations of Camerawork Identification Unit 122b

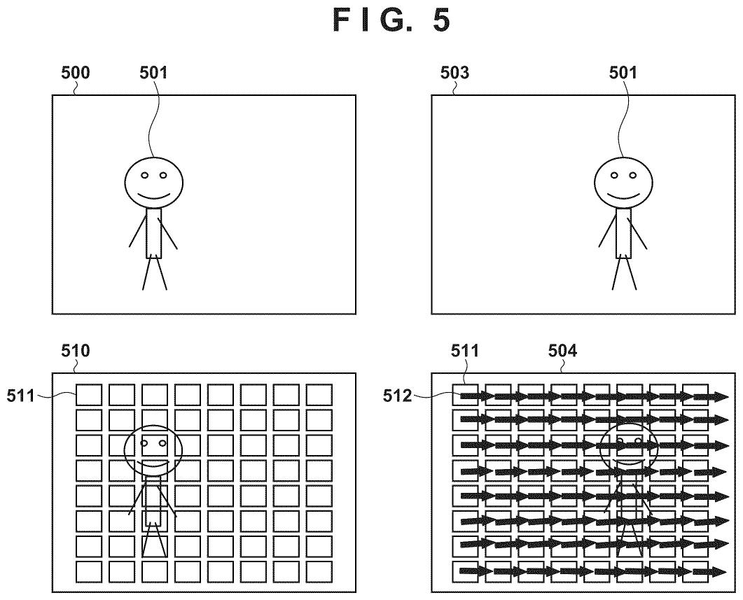

FIG. 4 is a flowchart illustrating the overall operations performed by the camerawork identification unit 122b. As mentioned above, the camerawork identification unit 122b is a function of the capturing information data generation unit 122. As such, the operations of the camerawork identification unit 122b are actually performed by the moving image file generation unit 12.

In step S401, the camerawork identification unit 122b obtains the detection result by the motion vector detection unit 142 (motion vector information), which is stored in the RAM 101, for example.

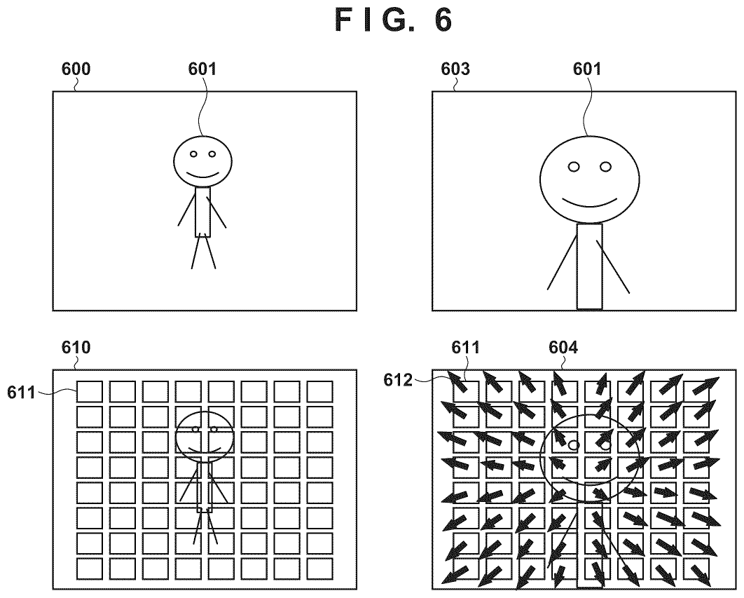

The motion vector will be described here. In FIG. 5, 500 indicates a situation where both a subject 501 and the digital camera 1 are stopped from when a past frame (e.g., the most recent frame) was captured to when the current frame is captured. 503 indicates a situation where the subject 501 is stopped, but the digital camera 1 has moved horizontally to the left, from when the past frame (e.g., a most recent frame) was captured to when the current frame is captured. Note that although only the subject 501 appears in the image in FIG. 5, in reality, a background is also present.

510 schematically illustrates an example of regions 511 in the frame 500 where the motion vector detection unit 142 detects motion vectors, along with motion vectors detected for the individual regions. An example in which the motion vector detection unit 142 detects a motion vector for each of 64 regions 511 obtained by dividing the overall frame into eight even parts in the horizontal and vertical directions is illustrated here. FIG. 5 illustrates the individual regions 511 as being surrounded by blank space for the sake of simplicity, but in reality, no space is present around the regions 511. In the frame 500, neither the subject 501 nor the digital camera 1 has moved following the past frame, and the magnitudes of the motion vectors detected in the individual regions 511 are therefore zero.

On the other hand, in the frame 503, the subject 501 has not moved from the past frame, but the digital camera 1 has moved horizontally to the left. Motion vectors 512 oriented horizontally to the right are therefore detected in the individual regions 511, as indicated by 504.

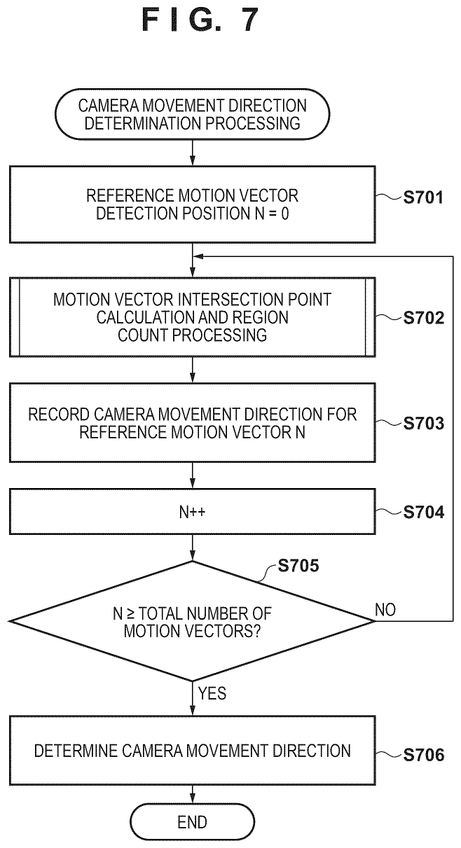

Meanwhile, in FIG. 6, 600 indicates a situation where both a subject 601 and the digital camera 1 are stopped from when a past frame (e.g., the most recent frame) was captured to when the current frame is captured. 603 indicates a situation where the subject 601 is stopped, but the digital camera 1 has moved forward in the optical axis direction, from when the past frame (e.g., a most recent frame) was captured to when the current frame is captured. Note that although only the subject 601 appears in the image in FIG. 6, in reality, a background is also present.

610 schematically illustrates an example of regions 611 in the frame 600 where the motion vector detection unit 142 detects motion vectors, along with motion vectors detected for the individual regions. The regions 611 are the same as the regions 511 in FIG. 5. In the frame 600, neither the subject 601 nor the digital camera 1 has moved following the past frame, and the magnitudes of the motion vectors detected in the individual regions 611 are therefore zero.

On the other hand, in the frame 603, the subject 601 has not moved from the past frame, but the digital camera 1 has moved forward in the optical axis direction. Motion vectors 612 oriented outward from the center of the image are therefore detected in the individual regions 611, as indicated by 604.

The camerawork identification unit 122b obtains motion vector information as the detection result by the motion vector detection unit 142 (e.g., image coordinates of the start and end points of the individual motion vectors). The vector information obtained here is assumed to include motion vector information for the frame as a whole, as well as motion vector information for the subject region.

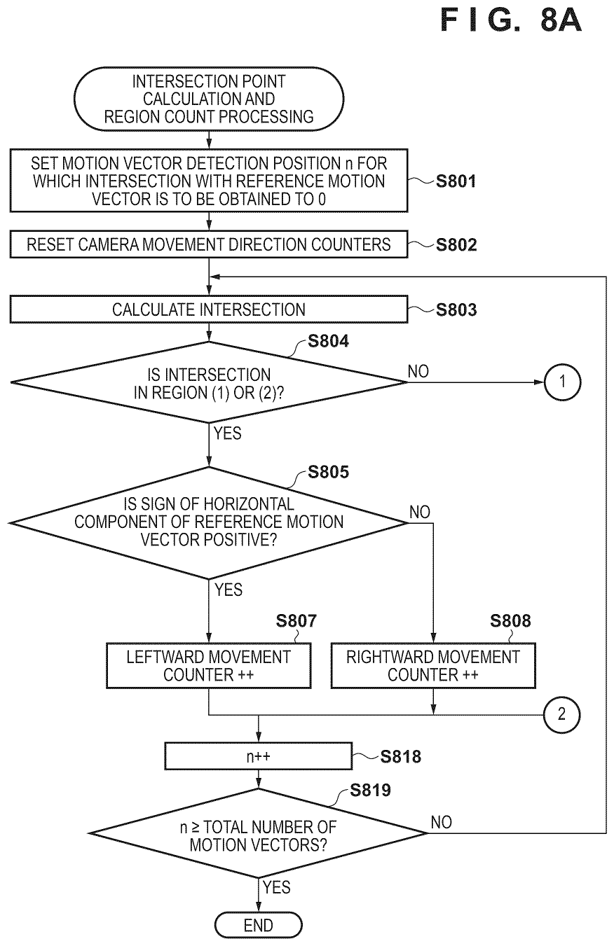

In step S402, the camerawork identification unit 122b executes movement direction determination processing for the digital camera 1 based on the motion vector information. Six types of movement directions are determined here, namely up, down, left, right, forward, and backward. The camerawork identification unit 122b stores information about the determined movement direction in the RAM 101. Details regarding the operations performed in step S402 will be given later with reference to FIG. 7.

In step S403, the camerawork identification unit 122b (first obtainment means) obtains the detection result by the subject information detection unit 141 from the RAM 101, for example. The RAM 101 is assumed to store the detection result by the subject information detection unit 141 for at least a plurality of the most recent frames (e.g., 30 frames).

In step S404, the camerawork identification unit 122b (second obtainment means) obtains information about movement of the digital camera 1. The information about the movement may be a signal output by the motion detection unit 123, for example.

In step S405, the camerawork identification unit 122b executes camerawork identification processing using the movement direction of the digital camera 1 determined in step S402, the subject detection result obtained in step S403, and the information about the movement obtained in step S404. The camerawork identification processing will be described in detail later. The camerawork identification unit 122b stores information indicating the type of the camerawork identified in the RAM 101, for example.

The camerawork identification unit 122b executes the foregoing operations every predetermined number of frames (e.g., every frame). The capturing information data generation unit 122 includes the information indicating the camerawork in the capturing information data as the camerawork information 224. The capturing information data 22 is associated with data of the frames constituting the moving image data 21. Accordingly, the camerawork performed when the moving image was captured can be known by referring to the moving image file. For example, presenting a total number of times or a total length of time for each instance of camerawork performed when capturing the moving image data 21 enables the photographer to understand the frequency, characteristics, and the like of the camerawork they used when capturing the image.

The camera movement direction determination processing executed by the camerawork identification unit 122b in step S402 of FIG. 4 will be described in detail next with reference to the flowchart in FIG. 7.

In step S701, the camerawork identification unit 122b resets a reference motion vector detection position N to 0. The reference motion vector detection position N is information specifying one of the 64 regions 511 in which a motion vector is detected, as described with reference to FIG. 5. The motion vector detected for the region specified by the reference motion vector detection position N is taken as a reference motion vector. The reference motion vector detection position N is an integer from 0 to 63, for example, where the region in the upper-left corner corresponds to 0, the region one place to the right thereof corresponds to 1, the region in the upper-right corner corresponds to 7, the region in the lower-left corner corresponds to 56, the region in the lower-right corner corresponds to 63, and so on.

In step S702, the camerawork identification unit 122b obtains an intersection between the direction of the reference motion vector and the direction of each of the other motion vectors. The value of a counter provided for each movement direction to be determined is then controlled based on the position of the intersection and the direction of the reference motion vector. These operations will be described in detail later. The counter may be a variable stored in the RAM 101, for example.

In step S703, the camerawork identification unit 122b stores the direction corresponding to the counter having the highest value, among the counters stored for each direction in the RAM 101, in association with the value of N, which serves as a candidate for the movement direction, in the RAM 101, for example. For example, if, for N=1, the value of the counter in the movement direction of “left” is the highest, the camerawork identification unit 122b stores “left” as a candidate for the movement direction in association with N=1 in the RAM 101. These operations will be described in detail later.

In step S704, the camerawork identification unit 122b adds 1 to the value of N.

In step S705, the camerawork identification unit 122b determines whether the value of N is greater than or equal to the total number of motion vectors (64). The camerawork identification unit 122b executes step S706 if the value of N is determined to be greater than or equal to the total number of motion vectors, and executes step S702 if not.

In step S706, the camerawork identification unit 122b determines the candidate having the highest frequency among the movement direction candidates associated with the respective values of N (0 to 63) as the movement direction of the digital camera 1. The camerawork identification unit 122b stores a value indicating the determined movement direction in the RAM 101, for example.

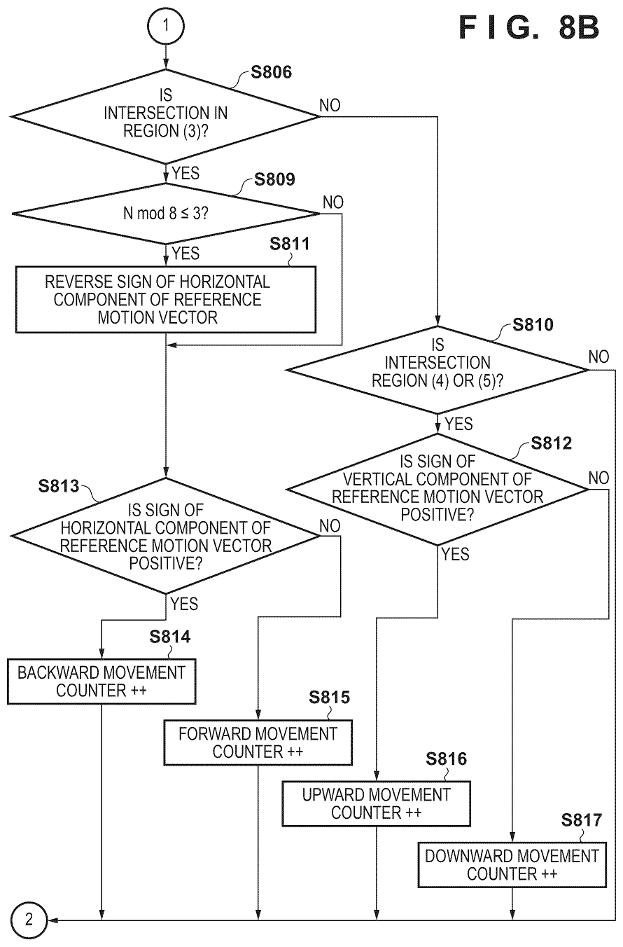

The processing of step S702 will be described in detail next with reference to the flowcharts in FIGS. 8A and 8B.

In step S801, the camerawork identification unit 122b resets a motion vector detection position n to be processed to 0. The motion vector detection position n is information specifying one motion vector detection position among the 64 for motion vector detection, aside from the reference motion vector detection position. Therefore, like the reference motion vector detection position N, the motion vector detection position n can be an integer from 0 to 63, but not a value equal to N.

In step S802, the camerawork identification unit 122b resets all the camera movement direction counters provided for the movement directions to be identified to zero. The camera movement direction counters can be implemented through any configuration that can be used as a counter, such as a variable stored in the RAM 101, for example. Here, it is assumed, as one example, that there are six movement directions to be identified, namely “leftward movement”, “rightward movement”, “backward movement”, “forward movement”, “upward movement”, and “downward movement”.

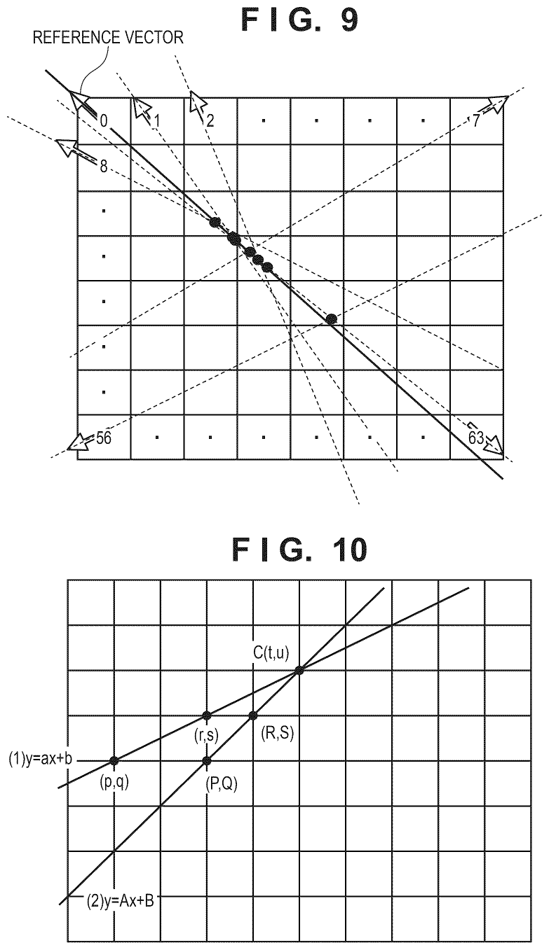

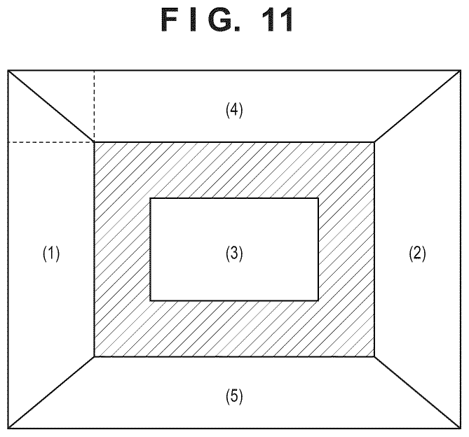

In step S803, the camerawork identification unit 122b calculates an intersection between the reference motion vector N and the motion vector n. The method for calculating the intersection will be described here with reference to FIGS. 9 and 10. FIG. 9 illustrates the 64 regions obtained by dividing the overall frame, and some of the motion vectors detected for individual regions.

It is assumed here that the reference motion vector detection position N is 0, i.e., that the motion vector detected for the region in the upper-left corner is the reference motion vector. In this case, the processing of steps S803 and on is executed repeatedly while the motion vector detection position n is within a range of 1 to 63.

In FIG. 9, the direction of the reference motion vector is indicated by a solid line, and the directions of the other motion vectors are indicated by dotted lines. In step S803, points of intersection between the direction of the reference motion vector (the solid line) and the directions of the other motion vectors (the dotted lines) are calculated. The calculated points of intersection are indicated by black circles in FIG. 9. To avoid complicating the figure, only the points of intersection calculated between the reference motion vector and the motion vectors for which n is 1, 2, 7, 8, 56, and 63 are indicated in FIG. 9. However, in reality, points of intersection are calculated sequentially for the motion vectors for which n is 1 to 63. A straight line indicating the direction of a vector will be called an “extension line” of the vector hereinafter. Accordingly, the processing of step S803 can also be called processing for calculating points of intersection between an extension line of the reference motion vector and extension lines of the other motion vectors.

A method for calculating the intersection between vector extension lines will be described with reference to FIG. 10. The intersection between two vector extension lines can be obtained by solving simultaneous equations made up of linear functions expressing the extension lines.

For example, in FIG. 10, y=ax+b represents the extension line of the reference motion vector, and y=Ax+B represents the extension line of the other motion vector. When the coordinates of the start and end points of the reference motion vector are represented by (p, q) and (r, s), respectively, then a=(s−q)/(r−p) and b=q−ap. When the coordinates of the start and end points of the other motion vector are represented by (P, Q) and (R, S), then A=(S−Q)/(R−P) and B=Q−AP. In this case, an intersection C(t, u) of the two straight extension lines can be calculated as (t, u)=((B−b)/(a−A), (aB−Ab)/(a−A)). Here, a, b, A, and B are all obtained from the coordinate values, and the intersection can therefore be calculated directly from the coordinate values.

The motion vector information is the image coordinates of the start and end points, taking reference coordinates (e.g., center coordinates) of the motion vector detection region as the origin. Accordingly, in step S803, the camerawork identification unit 122b calculates the intersection between the extension lines of the reference motion vector and one other motion vector, based on the coordinate values thereof.

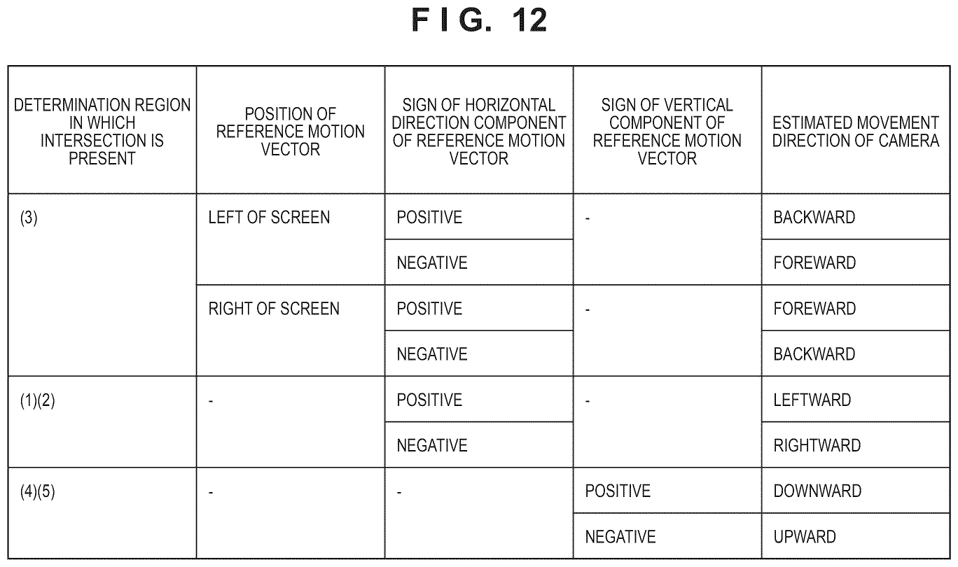

Steps S804 and on are processing for increasing the value of the counter for each direction in accordance with combinations of the position of the intersection within the frame and the direction (the sign) of the reference motion vector. In the present embodiment, a predetermined plurality of determination regions are set in the image, and the value is increased for one counter according to a combination of the determination region that contains the position of the intersection and the direction (the sign) of the reference motion vector. FIG. 11 illustrates an example of the setting of the determination regions. It is assumed here that a total of five determination regions (1) to (5), namely one each of an upper, lower, left, and right peripheral region and one region in the center of the image, are set.

Determination regions are not set in the hatched part. Boundary parts of the determination regions set in the peripheral regions (the quadrangular regions indicated by lines for the determination regions (1) to (4)) may be excluded from the determination regions, or used as separate determination regions. The determination regions (1) and (2) are set to correspond to the left and right directions; (3), to the forward and backward directions; and (4) and (5), to the up and down directions, respectively. Setting information for the determination regions is assumed to be stored in the ROM 102, for example.

Returning to FIG. 8A, in step S804, the camerawork identification unit 122b determines whether the intersection calculated in step S803 is within the determination region (1) or (2). The camerawork identification unit 122b executes step S805 if the intersection is determined to be within the determination region (1) or (2), and executes step S806 if not.

In step S805, the camerawork identification unit 122b determines whether the sign of a horizontal component of the reference motion vector is “positive”. It is assumed here that in an image, movement in the right direction and the upward direction is “positive”, and the movement in the left direction and the downward direction is “negative”. Accordingly, the camerawork identification unit 122b determines that the sign of the horizontal component is “positive” if the horizontal (x) coordinates of the start and end points of the reference motion vector are increasing, and determines that the sign of the horizontal component is “negative” if those coordinates are decreasing. The camerawork identification unit 122b executes step S807 if the sign of the horizontal component of the reference motion vector is determined to be “positive”, and executes step S808 if not.

In step S807, the camerawork identification unit 122b increases the value of the counter for leftward movement by 1. The camerawork identification unit 122b then executes step S818.

In step S808, the camerawork identification unit 122b increases the value of the counter for rightward movement by 1. The camerawork identification unit 122b then executes step S818.

In step S806, the camerawork identification unit 122b determines whether the intersection calculated in step S803 is within the determination region (3). The camerawork identification unit 122b executes step S809 if the intersection is determined to be within the determination region (3), and executes step S810 if not.

In step S809, the camerawork identification unit 122b determines whether a remainder obtained when the reference motion vector detection position N is divided by 8 is less than or equal to 3 (N mod 8≤3). The camerawork identification unit 122b executes step S811 if N mod 8≤3 is determined to be true, and executes step S813 if not. Step S809 is a determination as to whether the start point of the reference motion vector is present in the left half or the right half of the image, and may therefore be made through another method. The camerawork identification unit 122b executes step S811 if the start point of the reference motion vector is determined to be present in the left half of the image, and executes step S813 if not.

In step S811, the camerawork identification unit 122b reverses the sign of the horizontal component of the reference motion vector. The camerawork identification unit 122b then executes step S813. If N mod 8≤3, the start point of the reference motion vector is present in the left half of the image. Because the determination region (3) corresponds to the forward-backward direction, the motion vector is oriented from the center of the image toward the outside, or from the outside toward the center of the image. In this case, the signs of the horizontal direction components of the motion vectors corresponding to the same movement direction are reversed between the motion vector having a start point in the left half of the image and the motion vector having a start point in the left half of the image. Accordingly, in step S811, the sign of the horizontal component of the reference motion vector for which the start point is present in the left half of the image is reversed.

In step S813, the camerawork identification unit 122b determines whether the sign of a horizontal component of the reference motion vector is “positive”. The camerawork identification unit 122b executes step S814 if the sign of the horizontal component of the reference motion vector is determined to be “positive”, and executes step S815 if not.

In step S814, the camerawork identification unit 122b increases the value of the counter for backward movement by 1. The camerawork identification unit 122b then executes step S818.

In step S815, the camerawork identification unit 122b increases the value of the counter for forward movement by 1. The camerawork identification unit 122b then executes step S818.

Although the horizontal component of the reference motion vector is used to identify the forward-backward direction here, the vertical component may be used instead. In this case, in step S809, whether the start point of the reference motion vector is present in the upper half or the lower half of the image is determined. This determination can be implemented as a determination as to whether the reference motion vector detection position N is greater than the total number of motion vector detection regions (64) divided by 2 (N>32), for example. The camerawork identification unit 122b executes step S811 if N>32 is determined to be true, and executes step S813 if not. Then, in step S811, the camerawork identification unit 122b reverses the sign of the vertical component of the reference motion vector. In step S813, whether the sign of the vertical component is “positive” is determined. Step S814 is executed if the sign of the vertical component of the reference motion vector is determined to be “positive”, and step S815 is executed if not.

In step S810, the camerawork identification unit 122b determines whether the intersection calculated in step S803 is within the determination region (4) or (5). The camerawork identification unit 122b executes step S812 if the intersection is determined to be within the determination region (4) or (5), and executes step S818 if not.

In step S812, the camerawork identification unit 122b determines whether the sign of the vertical component of the reference motion vector is “positive”. The camerawork identification unit 122b executes step S816 if the sign of the vertical component of the reference motion vector is determined to be “positive”, and executes step S817 if not.

In step S816, the camerawork identification unit 122b increases the value of the counter for upward movement by 1. The camerawork identification unit 122b then executes step S818.

In step S817, the camerawork identification unit 122b increases the value of the counter for downward movement by 1. The camerawork identification unit 122b then executes step S818.

In step S818, the camerawork identification unit 122b increases n by 1. If n increased by 1 is the same value as N, the camerawork identification unit 122b increases n by 1 again. The camerawork identification unit 122b then executes step S819.

In step S819, the camerawork identification unit 122b determines whether the value of n is greater than or equal to the total number of detection regions for motion vectors (64, here). The camerawork identification unit 122b ends the operations illustrated in FIGS. 8A and 8B and executes step S703 if the value of n is determined to be greater than or equal to the total number of detection regions for motion vectors, and executes step S803 if not.

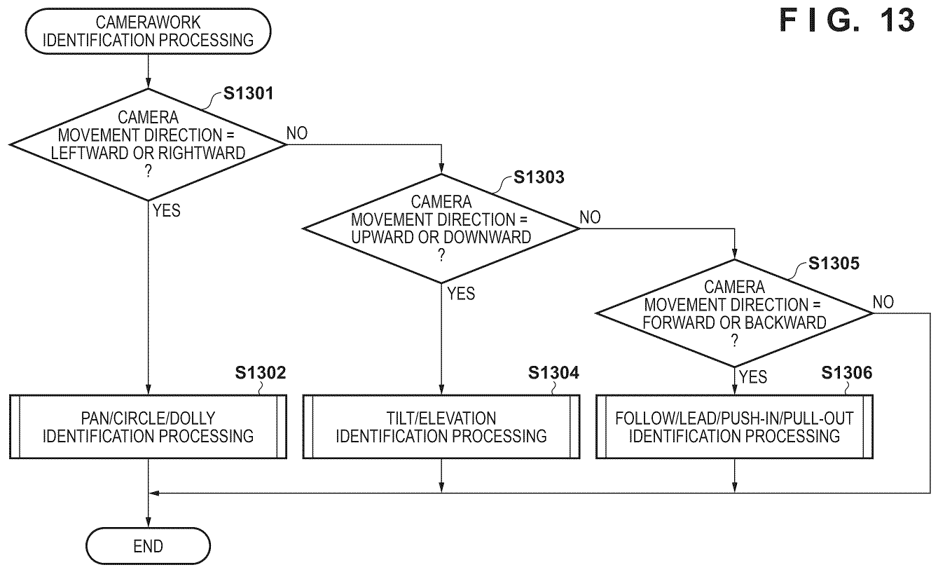

The processing described with reference to FIGS. 8A and 8B is based on the relationship between the position of the intersection, the position of the start point of the reference motion vector, the sign of the horizontal or vertical component of the reference motion vector, and the estimated movement direction of the digital camera 1, as indicated in FIG. 12.

### Camerawork Identification Processing

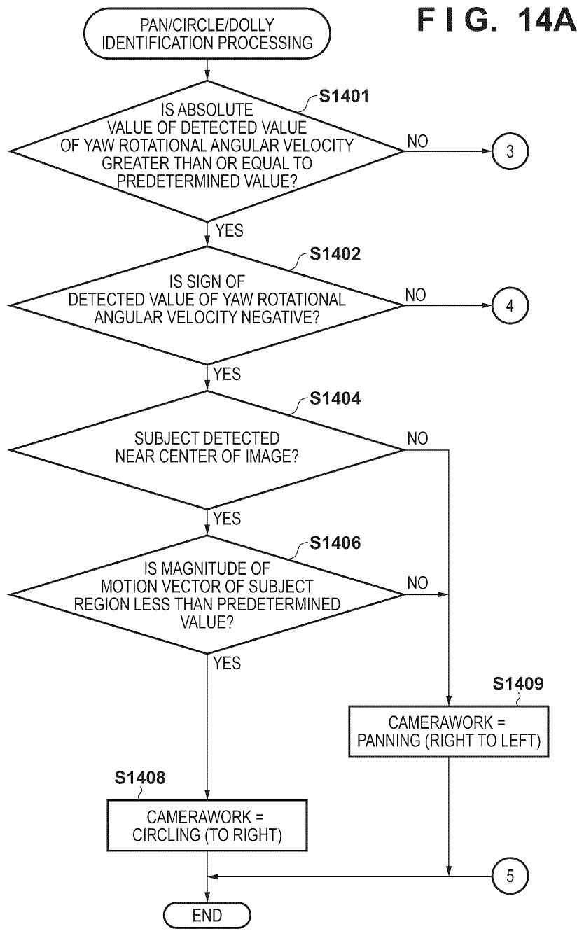

FIG. 13 is a flowchart illustrating, in detail, the camerawork identification processing performed by the camerawork identification unit 122b in step S405 of FIG. 4.

In step S1301, the camerawork identification unit 122b determines whether the camera movement direction obtained through the camera movement direction determination processing (step S402) is leftward or rightward. The camerawork identification unit 122b executes step S1302 if the camera movement direction is determined to be leftward or rightward, and executes step S1303 if not.

In step S1302, the camerawork identification unit 122b executes pan/circle/dolly identification processing. The camerawork identification unit 122b stores a value indicating the identification result in the RAM 101, for example, and ends the camerawork identification processing.

In step S1303, the camerawork identification unit 122b determines whether the camera movement direction obtained through the camera movement direction determination processing (step S402) is upward or downward. The camerawork identification unit 122b executes step S1304 if the camera movement direction is determined to be upward or downward, and executes step S1305 if not.

In step S1304, the camerawork identification unit 122b executes tilt/elevation identification processing. The camerawork identification unit 122b stores a value indicating the identification result in the RAM 101, for example, and ends the camerawork identification processing.

In step S1305, the camerawork identification unit 122b determines whether the camera movement direction obtained through the camera movement direction determination processing in step S402 is forward or backward. The camerawork identification unit 122b executes step S1306 if the camera movement direction is determined to be forward or backward, and ends the camerawork identification processing without identifying the camerawork if not.

In step S1306, the camerawork identification unit 122b executes follow/lead/push-in/pull-out identification processing. The camerawork identification unit 122b stores a value indicating the identification result in the RAM 101, for example, and ends the camerawork identification processing.

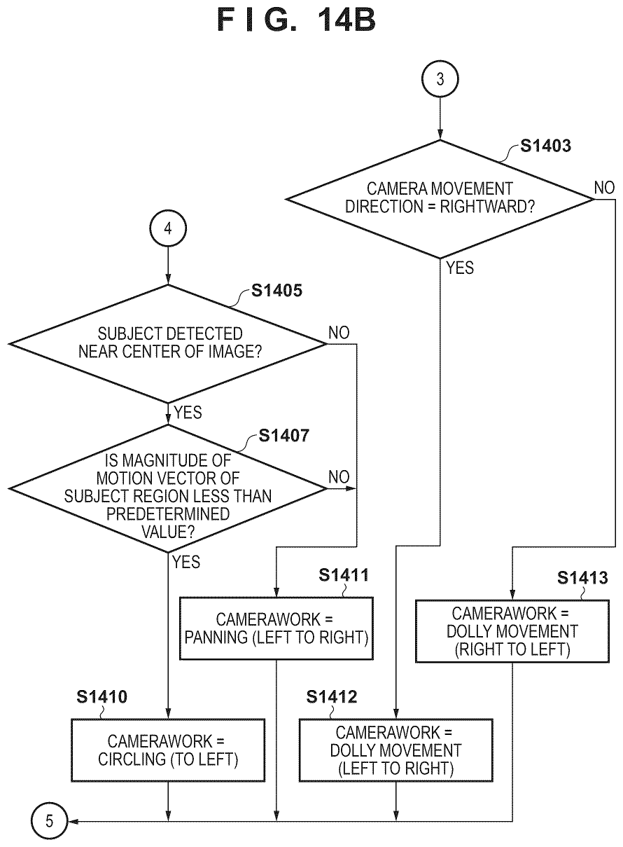

FIGS. 14A and 14B are flowcharts illustrating, in detail, the pan/circle/dolly identification processing performed in step S1302.

In step S1401, the camerawork identification unit 122b determines, from the information about the movement of the digital camera 1 obtained from the motion detection unit 123 in step S404, whether an absolute value of an angular velocity (rad/s) of rotation about the yaw axis (the z axis) is greater than or equal to a predetermined value. The predetermined value may be a fixed or variable value. The predetermined value is assumed to be stored in the ROM 102 in advance. The camerawork identification unit 122b executes step S1402 if the absolute value of the angular velocity for yaw is determined to be greater than or equal to the predetermined value, and executes step S1403 if not.

In step S1402, the camerawork identification unit 122b determines whether the sign of the angular velocity for yaw is negative. The camerawork identification unit 122b executes step S1404 if the sign of the angular velocity for yaw is determined to be negative, and executes step S1405 if not.

In step S1404, the camerawork identification unit 122b determines, based on the subject information obtained in step S403, whether a subject has been detected near the center of the image. The camerawork identification unit 122b determines that a subject has been detected near the center of the image when, for example, a distance between the position of the subject region included in the subject information and the center coordinates of the image is no greater than a predetermined value. The predetermined value is assumed to be stored in the ROM 102 in advance. The camerawork identification unit 122b executes step S1406 if a subject is determined to be detected near the center of the image, and executes step S1409 if not. Note that the camerawork identification unit 122b may determine that a subject has been detected near the center of the image when both (i) the distance between the position of the subject region and the center coordinates of the image is no greater than a predetermined value and (ii) the center coordinates of the image are within the subject region.

In step S1406, the camerawork identification unit 122b determines, based on the motion vector information obtained in step S401, whether the magnitude of the motion vector detected for the subject region is less than a predetermined value. The predetermined value is assumed to be stored in the ROM 102 in advance. The camerawork identification unit 122b determines that the magnitude of the motion vector is less than the predetermined value if, for example, the sum of squares (or the square root of the sum of squares) of the horizontal and vertical components of the motion vector detected for the subject information is less than a predetermined value. The camerawork identification unit 122b executes step S1408 if the magnitude of the motion vector is determined to be less than the predetermined value, and executes step S1409 if not.

In step S1408, the camerawork identification unit 122b identifies the camerawork as “circling (to the right)”. The camerawork identification unit 122b stores information specifying the identified camerawork in the RAM 101, for example, and ends the pan/circle/dolly identification processing.

In step S1409, the camerawork identification unit 122b identifies the camerawork as “panning (right to left)”. The camerawork identification unit 122b stores information specifying the identified camerawork in the RAM 101, for example, and ends the pan/circle/dolly identification processing.

In step S1405, the camerawork identification unit 122b determines whether a subject has been detected near the center of the image, in the same manner as in step S1404. The camerawork identification unit 122b executes step S1407 if a subject is determined to be detected near the center of the image, and executes step S1411 if not.

In step S1407, the camerawork identification unit 122b determines whether the magnitude of the motion vector detected for the subject region is less than a predetermined value, in the same manner as in step S1406. The camerawork identification unit 122b executes step S1410 if the magnitude of the motion vector is determined to be less than the predetermined value, and executes step S1411 if not.

In step S1410, the camerawork identification unit 122b identifies the camerawork as “circling (to the left)”. The camerawork identification unit 122b stores information specifying the identified camerawork in the RAM 101, for example, and ends the pan/circle/dolly identification processing.

In step S1411, the camerawork identification unit 122b identifies the camerawork as “panning (left to right)”. The camerawork identification unit 122b stores information specifying the identified camerawork in the RAM 101, for example, and ends the pan/circle/dolly identification processing.

In step S1403, the camerawork identification unit 122b determines whether the camera movement direction obtained through the camera movement direction determination processing in step S402 is rightward. The camerawork identification unit 122b executes step S1412 if the camera movement direction is determined to be rightward, and executes step S1413 if not.

In step S1412, the camerawork identification unit 122b identifies the camerawork as “dolly movement (left to right)”. The camerawork identification unit 122b stores information specifying the identified camerawork in the RAM 101, for example, and ends the pan/circle/dolly identification processing.

In step S1413, the camerawork identification unit 122b identifies the camerawork as “dolly movement (right to left)”. The camerawork identification unit 122b stores information specifying the identified camerawork in the RAM 101, for example, and ends the pan/circle/dolly identification processing.

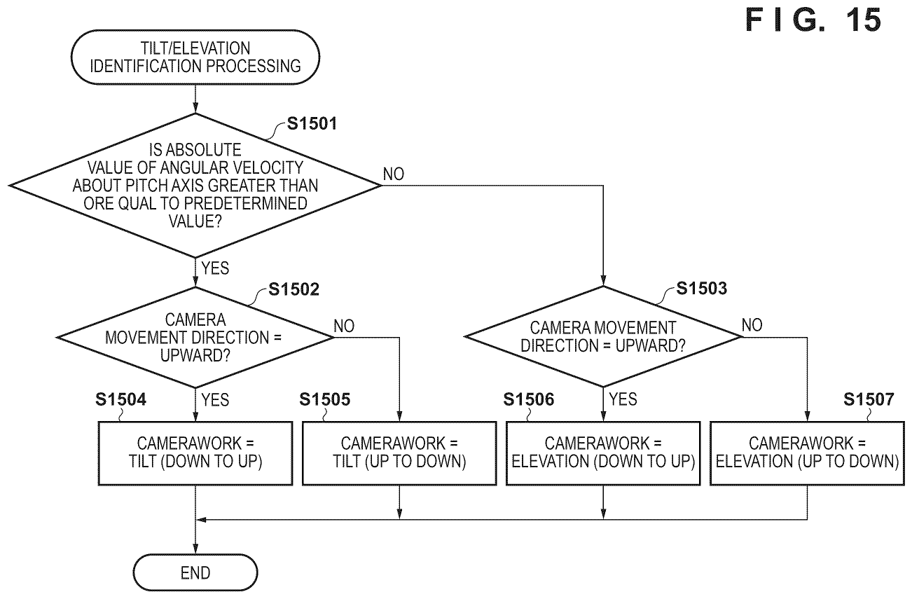

FIG. 15 is a flowchart illustrating, in detail, the tilt/elevation identification processing performed in step S1304.

In step S1501, the camerawork identification unit 122b determines, from the information about the movement of the digital camera 1 obtained from the motion detection unit 123 in step S404, whether an absolute value of an angular velocity (rad/s) of rotation about the pitch axis (the y axis) is greater than or equal to a predetermined value. The predetermined value may be a fixed or variable value. The predetermined value is assumed to be stored in the ROM 102 in advance. The camerawork identification unit 122b executes step S1502 if the absolute value of the angular velocity for pitch is determined to be greater than or equal to the predetermined value, and executes step S1503 if not.

In step S1502, the camerawork identification unit 122b determines whether the camera movement direction obtained through the camera movement direction determination processing in step S402 is upward. The camerawork identification unit 122b executes step S1504 if the camera movement direction is determined to be upward, and executes step S1505 if not.

In step S1504, the camerawork identification unit 122b identifies the camerawork as “tilt (down to up)”. The camerawork identification unit 122b stores information specifying the identified camerawork in the RAM 101, for example, and ends the tilt/elevation identification processing.

In step S1505, the camerawork identification unit 122b identifies the camerawork as “tilt (up to down)”. The camerawork identification unit 122b stores information specifying the identified camerawork in the RAM 101, for example, and ends the tilt/elevation identification processing.

In step S1503, the camerawork identification unit 122b determines whether the camera movement direction is upward, in the same manner as in step S1502. The camerawork identification unit 122b executes step S1506 if the camera movement direction is determined to be upward, and executes step S1507 if not.

In step S1506, the camerawork identification unit 122b identifies the camerawork as “elevation (down to up)”. The camerawork identification unit 122b stores information specifying the identified camerawork in the RAM 101, for example, and ends the tilt/elevation identification processing.

In step S1507, the camerawork identification unit 122b identifies the camerawork as “elevation (up to down)”. The camerawork identification unit 122b stores information specifying the identified camerawork in the RAM 101, for example, and ends the tilt/elevation identification processing.

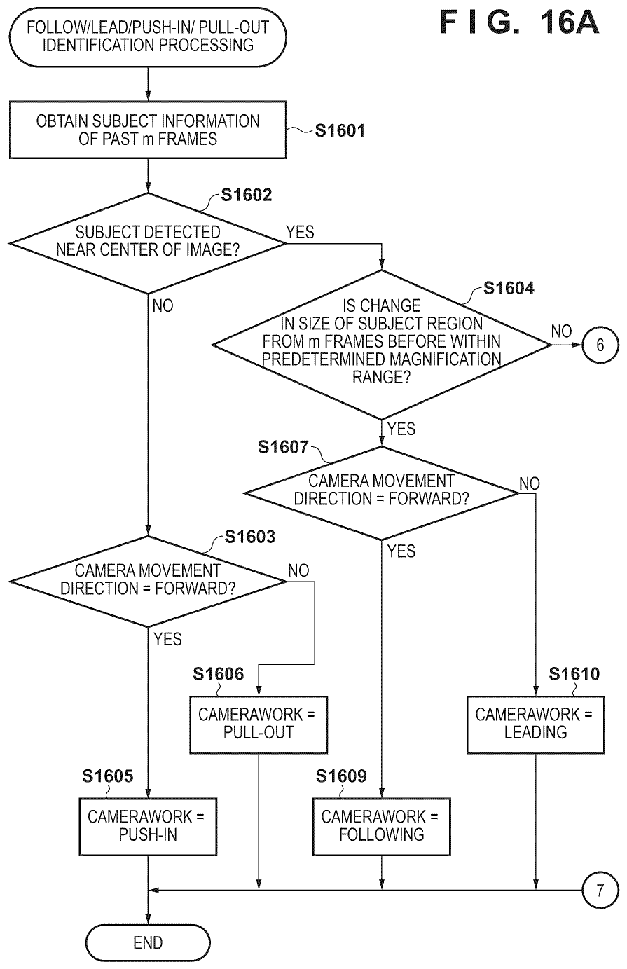

FIGS. 16A and 16B are flowcharts illustrating, in detail, the follow/lead/push-in/pull-out identification processing performed in step S1306.

In step S1601, the camerawork identification unit 122b obtains the subject information of the past m frames by referring to the RAM 101, for example. m is a plurality, e.g., 30. Although variable depending on the framerate, m can be a value corresponding to one to several seconds in the past, for example. The value of m in the case of 30 frames/second, for example, is assumed to be stored in the ROM 102.

In step S1602, the camerawork identification unit 122b determines whether a subject has been detected near the center of the image, in the same manner as in step S1404. The camerawork identification unit 122b executes step S1604 if a subject is determined to be detected near the center of the image, and executes step S1603 if not.

In step S1603, the camerawork identification unit 122b determines whether the camera movement direction obtained through the camera movement direction determination processing in step S402 is forward. The camerawork identification unit 122b executes step S1605 if the camera movement direction is determined to be forward, and executes step S1606 if not.

In step S1605, the camerawork identification unit 122b identifies the camerawork as “push-in”. The camerawork identification unit 122b stores information specifying the identified camerawork in the RAM 101, for example, and ends the follow/lead/push-in/pull-out identification processing.

In step S1606, the camerawork identification unit 122b identifies the camerawork as “pull-out”. The camerawork identification unit 122b stores information specifying the identified camerawork in the RAM 101, for example, and ends the follow/lead/push-in/pull-out identification processing.

In step S1604, the camerawork identification unit 122b determines, based on the subject information from m frames before, obtained in step S1601, and the newest subject information, obtained in step S403, whether a change in the size of the subject region detected near the center of the image is within a predetermined magnification range. The predetermined magnification range here is a range of around 1× for determining that there is little change, and may be a range of 0.85× to 1.15×, for example. The camerawork identification unit 122b executes step S1607 if the change in the size of the subject region detected near the center of the image is determined to be within the predetermined magnification range, and executes step S1608 if not.

In step S1607, the camerawork identification unit 122b determines whether the camera movement direction obtained through the camera movement direction determination processing is forward, in the same manner as in step S1603. The camerawork identification unit 122b executes step S1609 if the camera movement direction is determined to be forward, and executes step S1610 if not.

In step S1609, the camerawork identification unit 122b identifies the camerawork as “following”. The camerawork identification unit 122b stores information specifying the identified camerawork in the RAM 101, for example, and ends the follow/lead/push-in/pull-out identification processing.

In step S1610, the camerawork identification unit 122b identifies the camerawork as a “leading”. The camerawork identification unit 122b stores information specifying the identified camerawork in the RAM 101, for example, and ends the follow/lead/push-in/pull-out identification processing.

In step S1608, the camerawork identification unit 122b determines, based on the subject information from m frames before, obtained in step S1601, and the newest subject information, obtained in step S403, whether the size of the subject region detected near the center of the image is increasing. The camerawork identification unit 122b executes step S1611 if the size of the subject region detected near the center of the image is determined to be increasing, and executes step S1612 if not.

In step S1611, the camerawork identification unit 122b determines whether the camera movement direction obtained through the camera movement direction determination processing is forward, in the same manner as in step S1607. The camerawork identification unit 122b executes step S1613 if the camera movement direction is determined to be forward, and ends the follow/lead/push-in/pull-out identification processing without identifying the camerawork if not.

In step S1613, the camerawork identification unit 122b identifies the camerawork as “push-in”. The camerawork identification unit 122b stores information specifying the identified camerawork in the RAM 101, for example, and ends the follow/lead/push-in/pull-out identification processing.

In step S1612, the camerawork identification unit 122b determines whether the camera movement direction obtained through the camera movement direction determination processing in step S402 is backward. The camerawork identification unit 122b executes step S1614 if the camera movement direction is determined to be backward, and ends the follow/lead/push-in/pull-out identification processing without identifying the camerawork if not.

In step S1614, the camerawork identification unit 122b identifies the camerawork as “pull-out”. The camerawork identification unit 122b stores information specifying the identified camerawork in the RAM 101, for example, and ends the follow/lead/push-in/pull-out identification processing.

According to the present embodiment as described above, camerawork performed when capturing a moving image is identified by taking into account not only motion vectors obtained from the moving image, but also the movement of the camera that captured the moving image and information about a subject region. This makes it possible to identify more types of specific camerawork than in the past.

### Second Embodiment

A second embodiment of the present invention will be described next. In the present embodiment, in a camera system having a gimbal mechanism, camerawork is identified based on a gimbal control amount and the rotation angle detection amount.

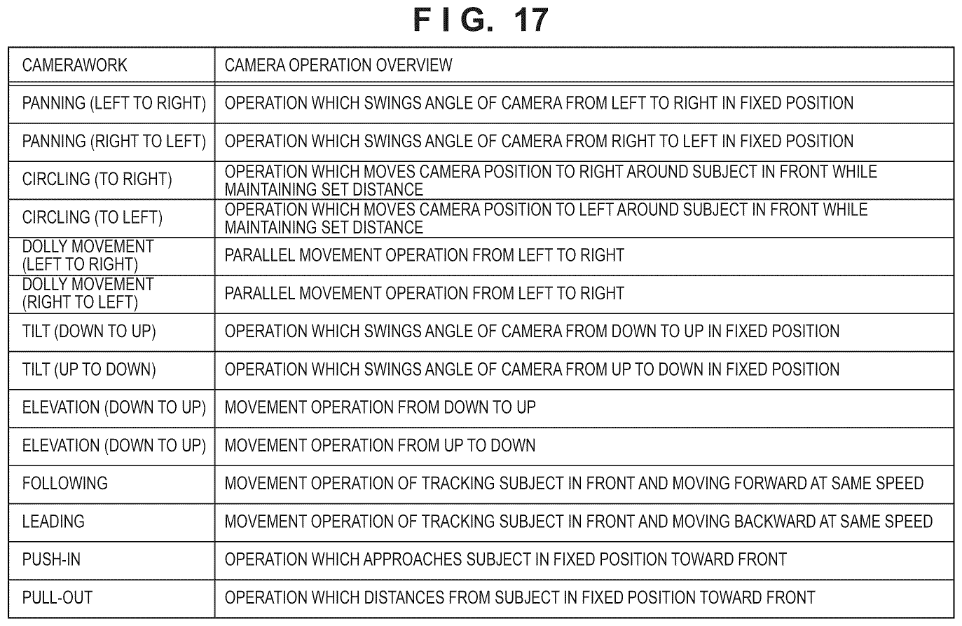

FIGS. 18A and 18B are diagrams illustrating an example of the appearance of a camera with an integrated gimbal mechanism (a gimbal camera) according to the present embodiment. FIG. 18A is a rear view, and FIG. 18B is a side view. The gimbal camera includes an image capture unit 180, a grip unit 182, and a gimbal unit 183. An angular velocity meter 181 similar to the motion detection unit 123 is provided within the image capture unit 180. Note that instead of a gimbal camera, the configuration may be such that a digital camera separate from the gimbal mechanism (which includes a grip unit) is mounted to the gimbal mechanism.

The grip unit 182 is the main part of the gimbal camera, held by the photographer or attached to a tripod, and is provided with operation members, a display member, and the like. The gimbal unit 183 is constituted by a three-axis rotary mechanism, for roll, pitch, and yaw, and arm parts that connect these, and prevents shake arising in the grip unit 182 from being transmitted to the image capture unit 180 using inertial force generated by a mechanical mechanism. Furthermore, shake that could not be suppressed by the mechanical mechanism is detected by the angular velocity meter 181, and the shake is suppressed by driving a motor provided in the rotary mechanism in accordance with the detected motion, which makes it possible to capture images while further suppressing such shake.

When the gimbal unit 183 performs antivibration control, the output of the angular velocity meter 181 is fed back at a fast sampling period to drive the motor of the rotary mechanism. As a result, the output of the angular velocity meter 181 provided in the image capture unit 180 takes on a value close to 0 in a state where vibrations are being suppressed in a stable manner. It is therefore difficult to determine whether the grip unit 182 is shaking from the output of the angular velocity meter 181.

On the other hand, because the gimbal unit 183 drives the rotary mechanism to cancel shake of the grip unit 182, the presence or absence of shake in the grip unit 182 can be determined by observing the control amount of the rotary mechanism of the gimbal unit 183. The presence or absence of shake in the grip unit 182 can also be determined by observing the rotation angle of the motor driven under the control of the gimbal unit 183 using a sensor such as an encoder.

In the present embodiment, the camerawork performed by the gimbal camera when capturing a moving image is identified based on the control amount or the rotation angle of the motor for each axis of the rotary mechanism of the gimbal unit 183. In the present embodiment, too, it is not necessary to identify the camerawork when capturing the moving image. If the control amount of the rotary mechanism or the rotation angle of the motor for each axis of the gimbal unit 183 during capturing is recorded in association with the moving image data, the recorded moving image file can be used to identify the camerawork.

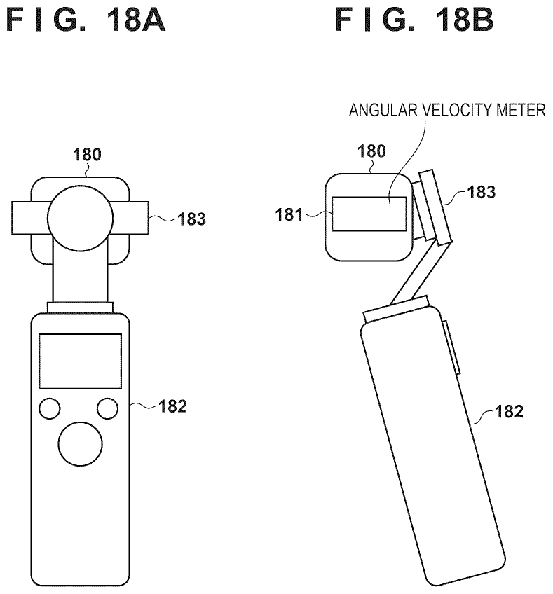

FIG. 19 is a block diagram illustrating an example of the functional configuration of a gimbal camera 200, serving as an example of an image processing apparatus according to the present embodiment, pertaining to the recording of moving images, along with a flow of processing. In FIG. 19, function blocks that are the same as those in the digital camera 1 are given the same reference signs as in FIG. 1. In addition, the configurations illustrated in FIGS. 18A and 18B are given the same reference signs as in FIGS. 18A and 18B.

A gimbal control unit 191 of a gimbal unit 19 obtains an angular velocity, which is an example of a signal expressing movement of the grip unit 182, from the motion detection unit 123. Then, based on the angular velocity, the gimbal control unit 191 calculates a gimbal control amount which cancels out movement of the grip unit 182. The gimbal control unit 191 drives a motor provided in a rotary mechanism 193 based on the calculated gimbal control amount. This makes it possible to suppress the effects of movement of the grip unit 182 on the attitude of the image capture unit 11, and stabilize the moving image captured by the image capture unit 11.

A gimbal angle detection unit 192 detects the rotation angle of the motor provided for each axis of the rotary mechanism 193. The gimbal angle detection unit 192 detects the rotation angle of the motor using a magnetic encoder that detects the rotation angle of a magnet attached to the motor, for example. The rotation angle of each axis detected by the gimbal angle detection unit 192 can be used in calculating the attitude of the image capture unit 180 relative to the grip unit 182 and the like. The relative attitude of the image capture unit 180 can be used to control a gimbal mode and the like. The “gimbal mode” includes, for example, a locked mode in which the image capture unit 180 is kept horizontal regardless of the direction in which the grip unit 182 is moved, a following mode in which movement of the grip unit 182 is followed, and the like. Changing the gimbal mode in accordance with the scene, the subject, and the like enables the photographer to capture images with appropriate camerawork while suppressing camera shake.

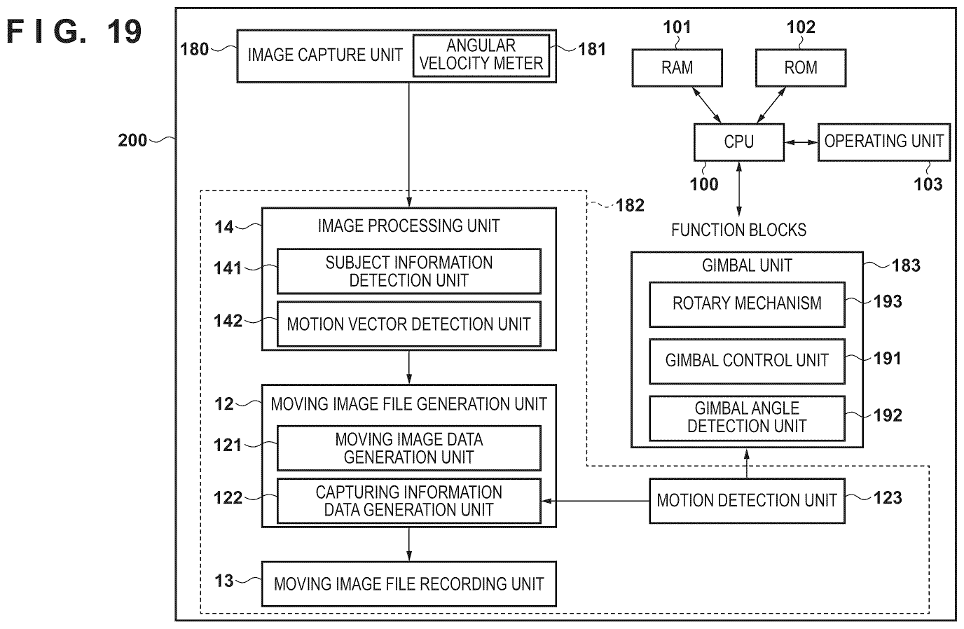

FIG. 20A schematically illustrates a situation in which a photographer holding the gimbal camera 200 takes a following shot of a moving subject 2000 from behind, while turning to the right. In such a situation, there are cases where the direction of the camerawork intended by the photographer cannot be correctly determined based on the direction of motion vectors.

FIG. 20B illustrates an example of motion vectors detected for a single frame 2010 of a moving image captured in the situation illustrated in FIG. 20A. A motion vector in the left direction is detected in each of motion vector detection regions 2011. When a motion vector in the left direction is detected, the camera movement direction determination processing illustrated in FIG. 7 determines “rightward movement.” As a result, in the camerawork identification processing (FIG. 13), a determination of “yes” is made in step S1301, and the camerawork is determined to be one of panning, circling, and dolly movement, regardless of whether a following shot is being taken.

Likewise, when taking a following shot while climbing a staircase or the like, motion vectors in the downward direction are detected. As a result, in the camera movement direction determination processing, “upward movement” is determined, and one of tilt and elevation is determined as the camerawork in the camerawork identification processing.

In the present embodiment, the control amount of the rotary mechanism, calculated by the gimbal control unit 191, or the rotation angle of the motor of the rotary mechanism, detected by the gimbal angle detection unit 192, is taken into account in addition to the motion vector information. This makes it possible to correctly identify the camerawork even when the photographer is taking a following shot while moving. These operations will be described in detail later.

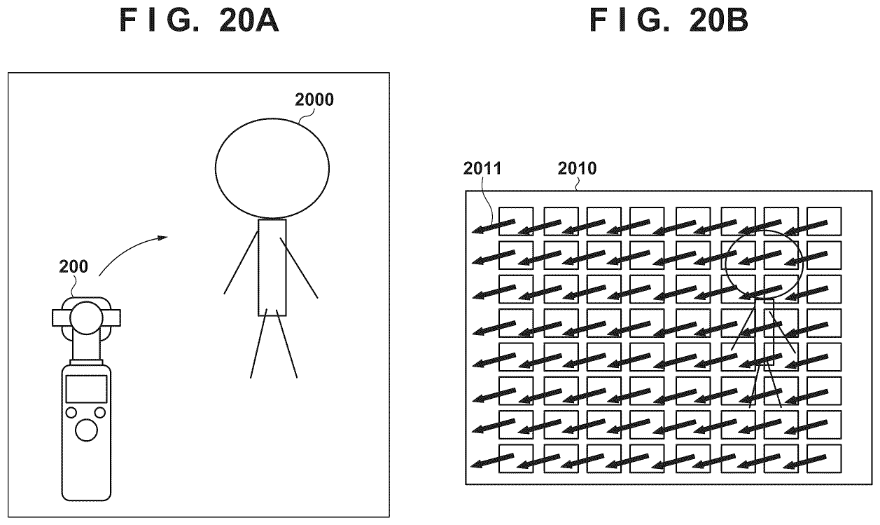

FIG. 21B schematically illustrates a situation in which a photographer is using the gimbal camera 200 to take a following shot, a push-in shot, or the like while following a subject in front of the photographer. FIG. 21A also illustrates a change in the gimbal control amount over time about the yaw, pitch, and roll axes in the capturing situation illustrated in FIG. 21B.

When capturing a moving image while following a subject in the front (while moving forward), the grip unit 182 of the gimbal camera 200 shakes mainly in the upward and downward direction. Accordingly, the amplitude of the gimbal control amount in the pitch direction increases compared to the control amount in the roll direction or the yaw direction. Accordingly, if, when the movement direction of the camera is determined to be leftward or rightward, the amplitude of the control amount in the pitch direction is greater than the control amount in the roll direction or the yaw direction, the camerawork can be identified as being following/leading/push-in/pull-out.

If the gimbal control amount for suppressing shake when the photographer is capturing while walking forward or backward is subjected to frequency analysis using a general method such as FFT, a waveform having a frequency substantially equal to the frequency of the walking motion can be detected. The frequency detected for the walking motion is relatively higher than the frequency detected for camerawork which swings the camera significantly upward or downward, such as tilt or elevation. Accordingly, a frequency threshold for identifying the frequency of the walking motion and the frequency of camerawork such as tilt and elevation can be set in advance. Therefore, if, when the movement direction of the camera is determined to be upward or downward, a frequency component higher than the frequency threshold is detected as the main frequency component of the gimbal control amount, the camerawork can be identified as being following/leading/push-in/pull-out. The main frequency component may be a frequency component for which the amplitude in the frequency spectrum is a maximum or greater than or equal to a threshold.

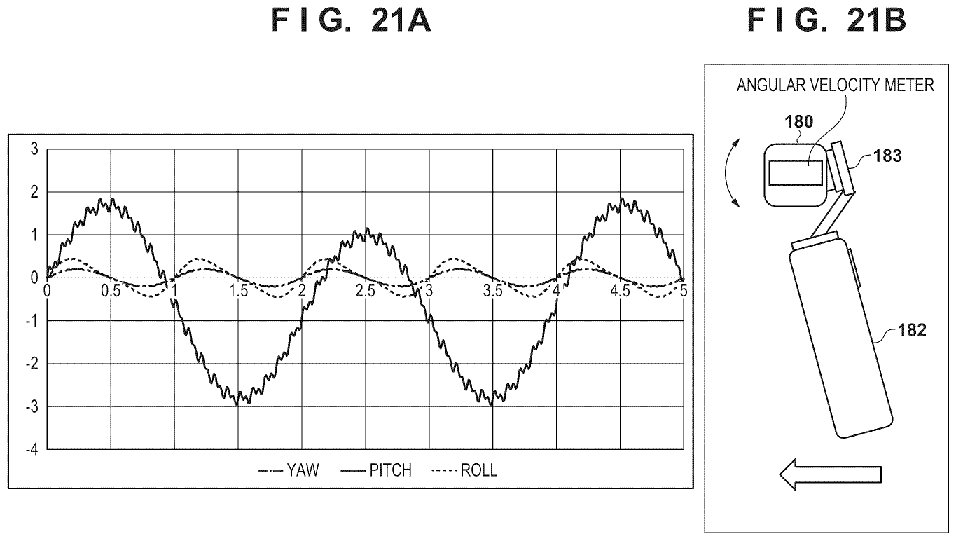

FIG. 22 is a flowchart illustrating, in detail, camerawork identification processing performed by the camerawork identification unit 122b in the present embodiment. In FIG. 22, steps in which the operations described in FIG. 13 are performed will be given the same reference signs as in FIG. 13, and will not be described. In the present embodiment, step S2201 is added between steps S1301 and S1302, and step S2202 is added between steps S1303 and S1304.

The camerawork identification unit 122b executes step S2201 if the camera movement direction is determined to be leftward or rightward in step S1301, and executes step S1303 if not.

In step S2201, the camerawork identification unit 122b compares the amplitudes of the gimbal control amounts for the roll, pitch, and yaw axes calculated by the gimbal control unit 191, and determines whether the amplitude of the gimbal control amount for the pitch axis is maximum. The camerawork identification unit 122b executes step S1306 if the amplitude of the gimbal control amount for the pitch axis is determined to be maximum, and executes step S1302 if not.

The camerawork identification unit 122b executes step S2202 if the camera movement direction is determined to be upward or downward in step S1303, and executes step S1305 if not.

In step S2202, the camerawork identification unit 122b performs frequency analysis on the gimbal control amount for the pitch axis calculated by the gimbal control unit 191 in a most recent predetermined period. The camerawork identification unit 122b then determines whether the frequency of the gimbal control amount for the pitch axis is greater than or equal to a predetermined frequency threshold. The camerawork identification unit 122b executes step S1306 if the frequency of the gimbal control amount for the pitch axis is determined to be greater than or equal to the predetermined frequency threshold, and executes step S1304 if not.

In this manner, the camerawork identification unit 122b of the present embodiment identifies, based on the gimbal control amount, whether the photographer is capturing a moving image while walking. The camerawork is then identified in accordance with whether the moving image is identified as being captured while walking, in addition to the result of determining the movement direction of the camera based on motion vectors. This makes it possible to appropriately identify camerawork for moving images captured while walking.

Note that FIG. 22 illustrates a case where whether a moving image is being captured while walking is identified based on the gimbal control amount. However, as described above, the rotation angle of the rotary mechanism of the gimbal unit 183 detected by the gimbal angle detection unit 192 may be used. In this case, whether the rotation angle for the pitch axis is maximum may be determined in step S2201, and the frequency of the rotation angle for the most recent predetermined period may be determined in step S2202.

In addition, whether the frequency in the roll direction or the yaw direction is greater than or equal to a frequency threshold may be determined, regardless of whether the gimbal control amount or the rotation angle of the rotary mechanism is used. For example, in step S2202, when the frequency is determined to be less than the frequency threshold for the roll direction and the yaw direction, and greater than or equal to the frequency threshold for the pitch direction, S1306 is executed. This makes it possible to increase the reliability of the determination.

Furthermore, the frequency threshold, the axis for determining the frequency, the tilt of the grip unit 182, and the like can be changed dynamically, a plurality of frequency thresholds can be set, or the like. Furthermore, the frequency analysis method is not limited to a form that uses conversions into the frequency domain, such as an FFT, and a simple analysis method that measures zero cross time and the time at which the amount of change inverts may be used instead.

### Third Embodiment

A third embodiment of the present invention will be described next. The present embodiment improves on the accuracy of the camerawork identification processing described in the first embodiment. The present embodiment can be carried out using the digital camera 1 described in the first embodiment. The present embodiment will therefore be described in detail hereinafter using the constituent elements illustrated in the block diagrams in FIGS. 1 to 3.

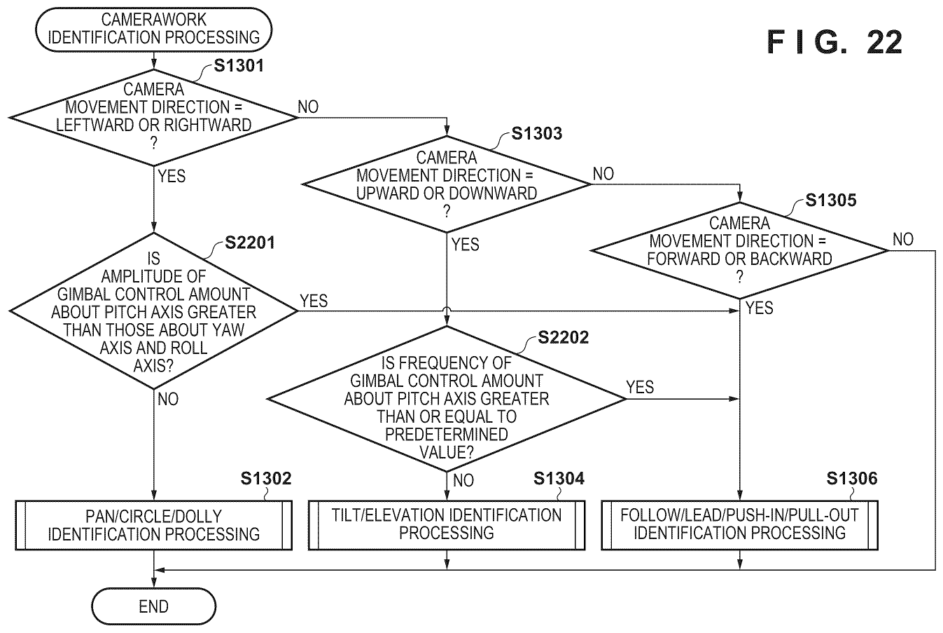

FIG. 23A is a diagram illustrating an example of motion vectors detected when taking a following shot of a subject moving in an oblique upward direction, while climbing a staircase or the like. When such a motion vector is detected, the intersection of the motion vector is within the determination region (4) in FIG. 11, and the sign of the vector is negative. “Upward movement” is therefore determined in the camera movement direction determination processing illustrated in FIG. 7. As a result, in the camerawork identification processing illustrated in FIG. 13, a determination of “yes” is made in step S1303, and the camerawork is determined to be one of tilt and elevation, even though a following shot is being taken.

FIG. 23B, meanwhile, is a diagram illustrating an example of motion vectors detected when taking a following shot of a subject that is moving forward at an angle. Even if such a motion vector is detected, the camerawork is determined to be one of panning, circling, and dolly movement, even though a following shot is being taken.

In the present embodiment, such camerawork for an image captured while moving oblique relative to the optical axis direction of the camera can be correctly identified by taking into account an angular distribution of the motion vectors.

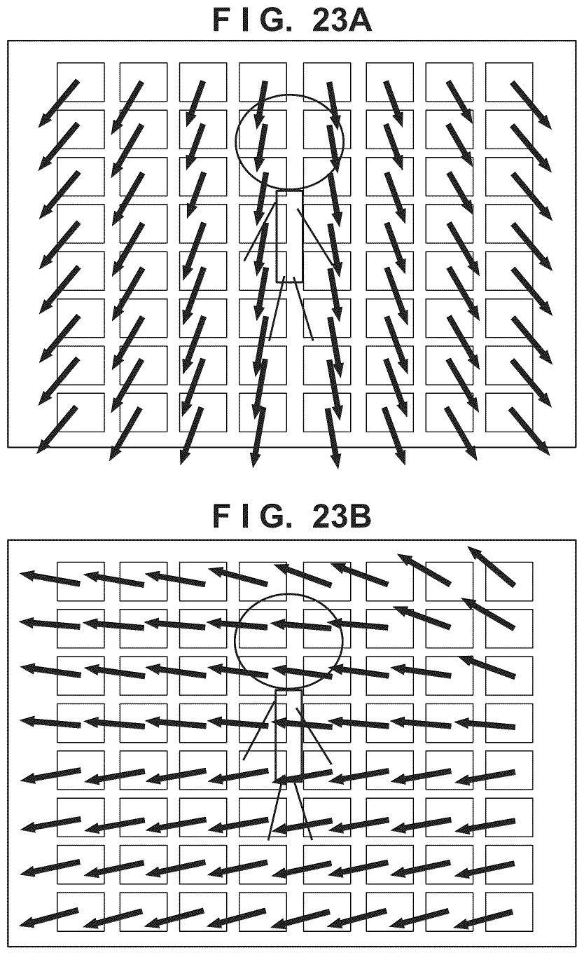

FIG. 24 is a flowchart illustrating, in detail, camera movement direction determination processing performed by the camerawork identification unit 122b in the present embodiment. In step S402 of FIG. 4, the camerawork identification unit 122b can perform steps S2401 to S2405 described below instead of steps S701 to S706 indicated in FIG. 7.

In step S2401, of the plurality of motion vectors included in the motion vector information of the entire frame, obtained in step S401 of FIG. 4, the camerawork identification unit 122b excludes vectors of less than a predetermined magnitude. Ensuring that motion vectors less than a predetermined magnitude are not considered in determining the movement direction of the camera suppresses the effects of fine movements, such as hand shake, on the result of determining the movement direction of the camera.

In step S2402, the camerawork identification unit 122b calculates a histogram of the angular distribution for the motion vectors not excluded in step S2401. The width of each bin of the histogram is assumed to be set in advance to a divisor of 360 (3 or greater).

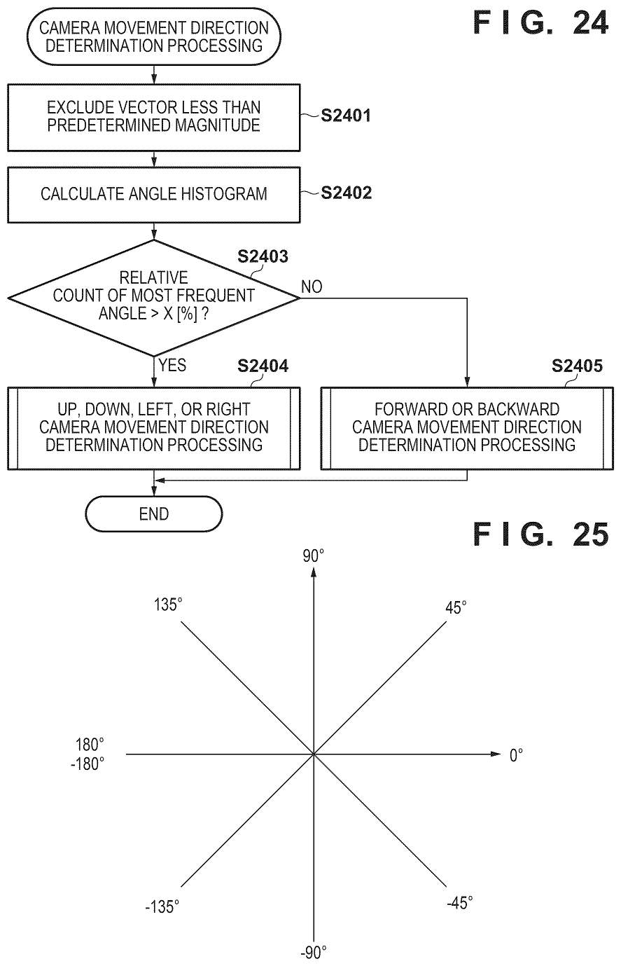

FIG. 25 is a diagram illustrating angles of motion vectors according to the present embodiment. In the present embodiment, the angle of a motion vector is assumed to have a range of ±180°, where the angle of the right-horizontal direction in the image is taken as a reference (0°), the angles in the counterclockwise direction are positive, and the angles in the clockwise direction are negative.

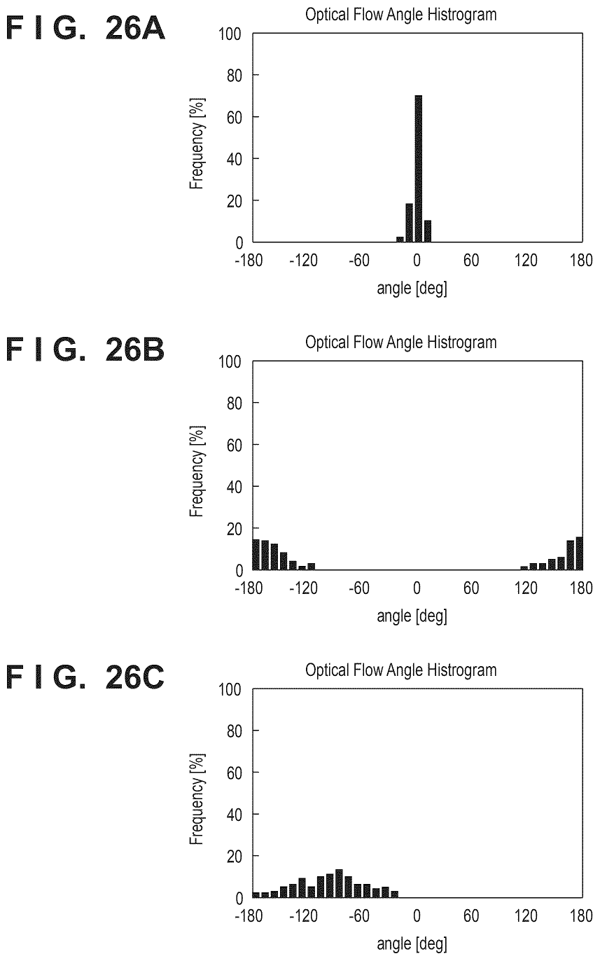

FIG. 26A illustrates a histogram of the angular distribution of the motion vectors indicated by 504 in FIG. 5. Significant peaks based on the movement direction appear in the angle histogram of motion vectors detected from an image captured using camerawork in which the camera is moved in up, down, left, and right directions that are orthogonal to the optical axis before the movement.

On the other hand, FIGS. 26B and 26C illustrate angle histograms of motion vectors detected from an image captured while moving the camera in an oblique direction relative to the optical axis direction before the movement, as in FIGS. 23A and 23B. An angle histogram of motion vectors detected from an image captured using camerawork that moves the camera in an oblique forward-backward direction relative to the optical axis direction before the movement has a relatively broad frequency distribution range, and does not have significant peaks.

There is thus a significant relationship between the movement direction and the magnitude of the peaks in the angle histogram. Accordingly, whether the movement direction of the camera is orthogonal to the optical axis (up, down, left, or right) or not (forward or backward (oblique)) can be determined according to whether the ratio of a maximum frequency (maximum count) to the total frequency in the angle histogram exceeds a predetermined value X (%).

The maximum frequency may be the frequency of one bin, or the total of the bin having the maximum frequency and the frequency of a plurality of bins, adjacent thereto, having at least a set frequency (e.g., at least an average frequency). A maximum number of bins (e.g., 3 to 5) for which the frequency is to be totaled may be provided. In the following, “maximum frequency” or “maximum count” is assumed to include both the frequency of one bin, and the total frequency of the plurality of bins.

In step S2403, the camerawork identification unit 122b calculates the ratio of the maximum frequency (maximum count) to the total frequency in the angle histogram as a relative count. The relative count can be calculated as the maximum count/total count, or the maximum frequency/total frequency. The camerawork identification unit 122b then determines whether the calculated relative count exceeds a predetermined threshold of X (%). X (%) can be defined experimentally in advance and stored in the ROM 102, for example.

The camerawork identification unit 122b executes step S2404 if the relative count is determined to exceed X (%), and executes step S2405 if not.

In step S2404, the camerawork identification unit 122b determines that the movement direction of the camera is up, down, left, or right orthogonal to the optical axis, and executes the corresponding camera movement direction determination processing.

In step S2405, the camerawork identification unit 122b determines that the movement direction of the camera is forward or backward (oblique) relative to the optical axis, and executes the corresponding camera movement direction determination processing.

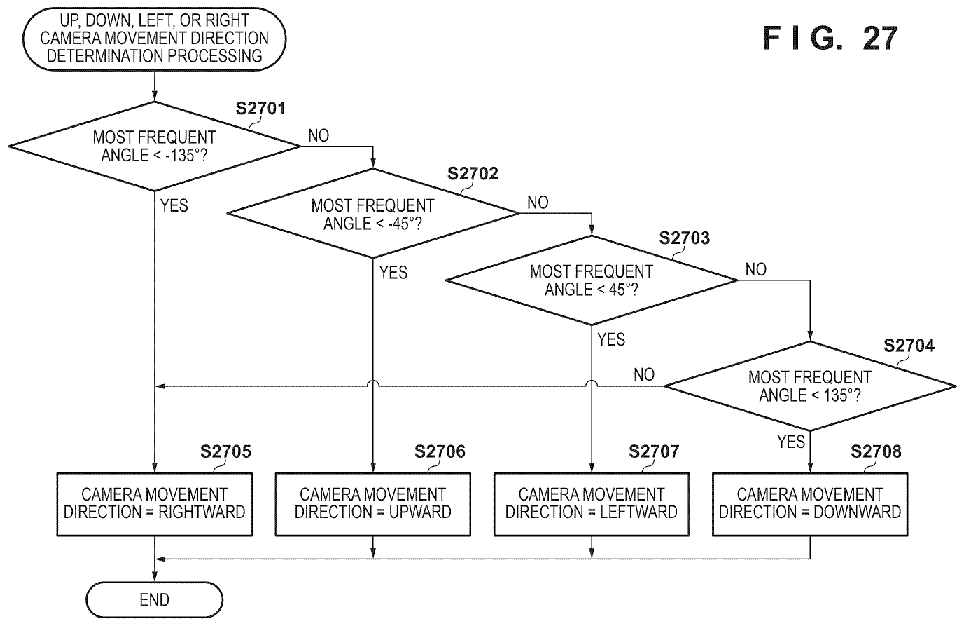

The camera movement direction determination processing executed in step S2404 will be described in detail next with reference to the flowchart in FIG. 27. As described above, when the movement direction of the camera is up, down, left, or right orthogonal to the optical axis, the angle histogram of motion vectors detected from the captured image has significant peaks. Because these peaks appear at angles corresponding to the movement direction, the movement direction of the camera can be determined by determining the angle of maximum frequency in the angle histogram.

The camerawork identification unit 122b determines the angle of maximum frequency in the angle histogram in steps S2701 to S2704, and in steps S2705 to S2708, specifies the movement direction of the camera to be either right, up, left, or down, in accordance with the determined angle.

Specifically, the camerawork identification unit 122b specifies the movement direction of the camera as follows, according to an angle θ (−180°≤θ<180°) of maximum frequency in the angle histogram:
if −180°≤θ<−135° (step S2701, Yes), the direction is right (step S2705);
if −135°≤θ<−45° (step S2702, Yes), the direction is up (step S2706);
if −45°≤θ<45° (step S2703, Yes), the direction is left (step S2707);
if 45°≤θ<135° (step S2704, Yes), the direction is down (step S2708); and
if 135°≤θ<180° (step S2704, No), the direction is right (step S2705).

Note that the angle θ of maximum frequency can be a representative value (e.g., a median value) of the range of angles corresponding to the one or more bins for which the maximum frequency has been obtained.

Note also that step S2404 is executed when the movement direction of the camera is determined to be up, down, left, or right. Accordingly, in step S2404, the movement direction of the camera may be specified based on the intersection between motion vectors, as in the first embodiment.

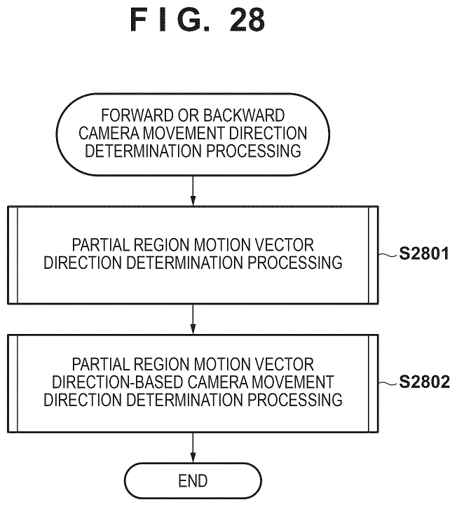

The camera movement direction determination processing executed in step S2405 will be described in detail next with reference to FIGS. 28 to 32.

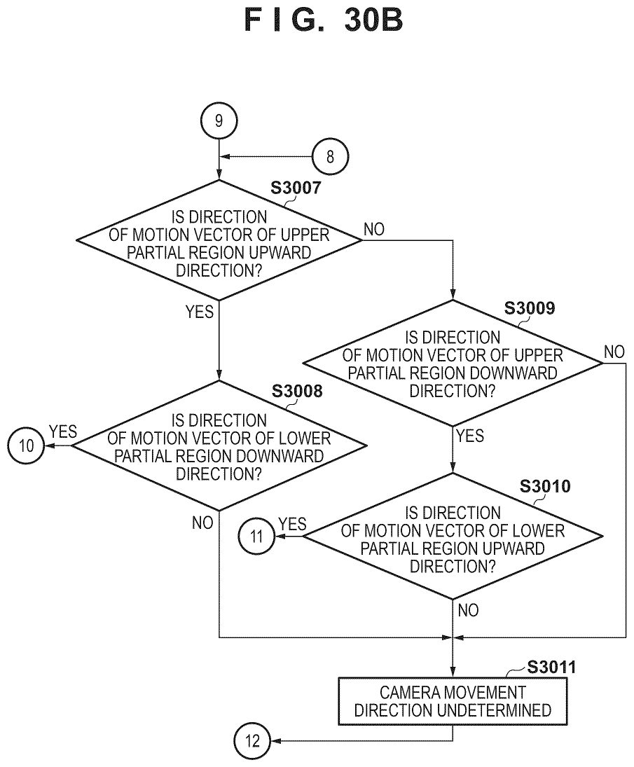

In step S2801 of FIG. 28, the camerawork identification unit 122b determines the direction of the motion vector for each of a plurality of specific partial regions in the frame. The plurality of specific partial regions are, for example, partial regions 3100 to 3103 illustrated in FIG. 31. In the present embodiment, for the sake of simplicity, of 64 regions obtained by dividing the entire frame equally into eight regions each in the horizontal and vertical directions, the 3×3 regions in the upper-right, upper-left, lower-right, and lower-left corners are taken as the specific partial regions. Note that the specific partial regions may be set as ranges in which a plurality of motion vectors are detected within each quadrant in a Cartesian coordinate system that takes the center of the image as the origin.

In step S2802, the camerawork identification unit 122b determines the movement direction of the camera based on the directions of the motion vectors determined for the partial regions in step S2801.

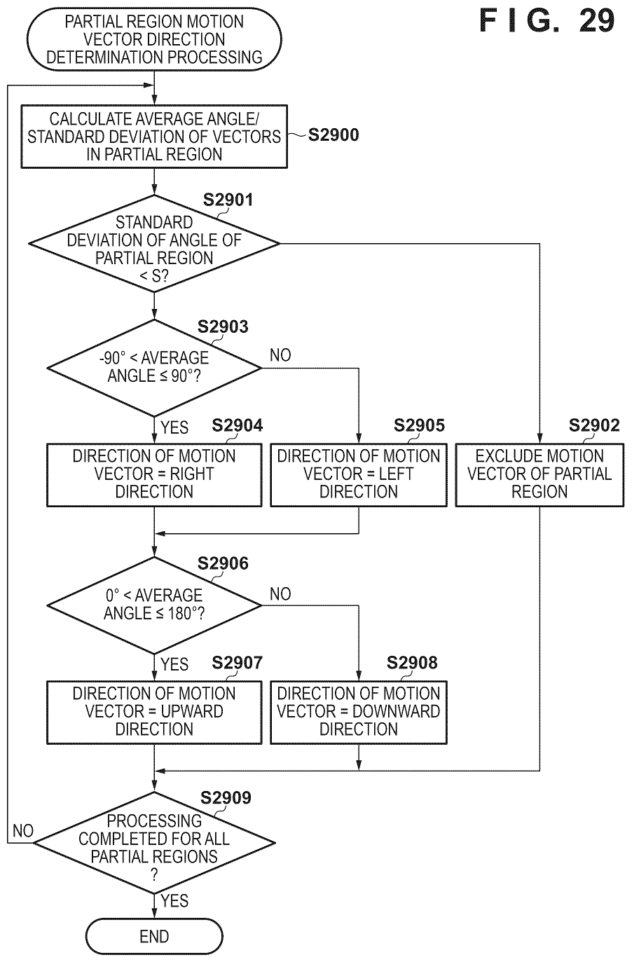

FIG. 29 is a flowchart illustrating, in detail, the motion vector direction calculation processing performed in step S2801. The camerawork identification unit 122b calculates the direction of the motion vector for each of the four partial regions 3100 to 3103.

In step S2900, the camerawork identification unit 122b calculates an average angle and a standard deviation (variation) of the angles for the plurality of motion vectors detected in the partial region in question, and stores those items in the RAM 101, for example.

In step S2901, the camerawork identification unit 122b determines whether the standard deviation of the angle calculated in step S2900 is less than a predetermined value S. This is a determination as to whether a moving subject is present in the partial region in question.

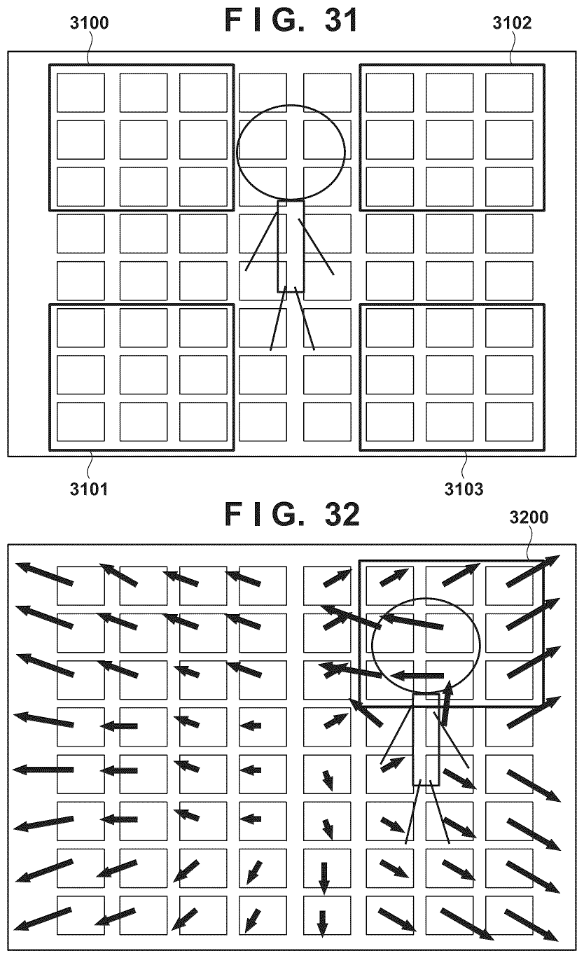

If a moving subject is present in the partial region, it is highly likely that the direction of the motion vector produced by movement of the camera is being disturbed by the motion vector produced by the moving subject in the partial region, as in the partial region 3200 in FIG. 32. Accordingly, a partial region having a high standard deviation for the angle (greater than or equal to the predetermined value S) can be determined to include a moving subject. Note that the predetermined value S can be set experimentally in advance and stored in the ROM 102, for example.

The camerawork identification unit 122b executes step S2903 if the standard deviation of the angle is determined to be less than the predetermined value S, and executes step S2902 if not.

In step S2902, the camerawork identification unit 122b excludes the motion vector of the partial region in question from the processing of steps S2903 to S2908, such that the motion vector does not affect the determination of the movement direction of the camera, and executes step S2909. In this manner, the direction of the motion vector is not determined for the partial region for which S2902 was executed.

In steps S2903 to S2905, the camerawork identification unit 122b determines the left/right directions of the motion vectors in the partial region in question.

In steps S2906 to S2908, the camerawork identification unit 122b determines the up/down directions of the motion vectors in the partial region in question.

In this manner, the direction of the horizontal component and the direction of the vertical component of the motion vector are determined for each partial region.

Specifically, in step S2903, the camerawork identification unit 122b determines whether the average angle θ calculated in step S2900 is −90°<θ≤90°, executes step S2904 if so, and executes step S2905 if not.

In step S2904, the camerawork identification unit 122b determines that the horizontal component of the motion vector of the partial region in question is the right direction, and executes step S2906.

In step S2905, the camerawork identification unit 122b determines that the horizontal component of the motion vector of the partial region in question is the left direction, and executes step S2906.

In step S2906, the camerawork identification unit 122b determines whether the average angle θ calculated in step S2900 is 0°<θ≤180°, executes step S2907 if so, and executes step S2908 if not.

In step S2907, the camerawork identification unit 122b determines that the vertical component of the motion vector of the partial region in question is the upward direction, and executes step S2909.

In step S2908, the camerawork identification unit 122b determines that the vertical component of the motion vector of the partial region in question is the downward direction, and executes step S2909.

In step S2909, the camerawork identification unit 122b determines whether the processing has been executed for all of the partial regions, ends the processing (executes step S2802) if so, and executes the processing from step S2900 for an unprocessed partial region if not.

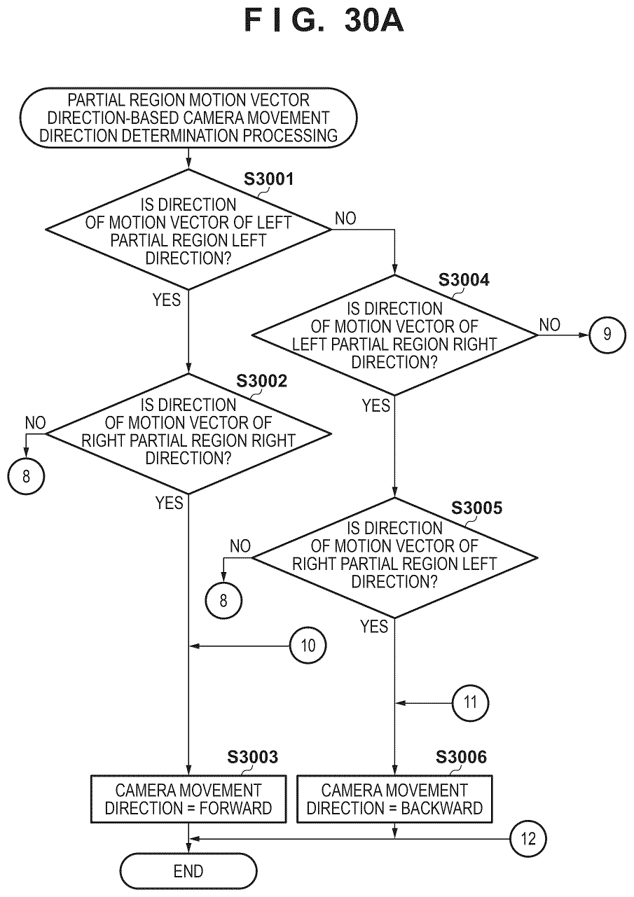

FIGS. 30A and 30B are flowcharts illustrating, in detail, the camera movement direction determination processing performed in step S2802. In the camera movement direction determination processing, the movement direction of the camera is determined based on the direction of each component of the motion vector determined in step S2801. Note that the partial region for which the direction of the motion vectors has not been determined in step S2801 is not taken into account in the camera movement direction determination processing.

In step S3001, the camerawork identification unit 122b determines whether the horizontal component of the motion vector determined in step S2801 is the left direction for the partial regions set in the left half of the image (the partial regions 3100 and 3101, in the example in FIG. 31). The camerawork identification unit 122b executes step S3002 if so, and executes step S3004 if not.

Note that when the directions of the motion vectors have been determined for the plurality of partial regions set in the left half of the image, in step S3001, the camerawork identification unit 122b determines whether all the horizontal components of the motion vectors determined in step S2801 are the left direction. Accordingly, if there is even one partial region for which the direction of the motion vector is determined to be in a direction other than the left direction, the camerawork identification unit 122b executes step S3004. Note also that when the number of partial regions used for the determination is high (greater than or equal to the threshold), whether the left direction has been determined at least a predetermined percentage of times (e.g., greater than or equal to 80%) may be determined. The same applies to the other steps for determining directions (steps S3002, S3004, S3005, S3007, S3008, S3009, and S3010).

In step S3002, the camerawork identification unit 122b determines whether the horizontal component of the motion vector determined in step S2801 is the right direction for the partial regions set in the right half of the image (the partial regions 3102 and 3103, in the example in FIG. 31). The camerawork identification unit 122b executes step S3003 if so, and executes step S3007 if not.

In step S3003, the camerawork identification unit 122b determines that the movement direction of the camerawork is forward. According to the present embodiment, the movement direction of the camera can be correctly determined to be forward, even when taking a following shot of a subject moving in an oblique upward direction, i.e., when a motion vector such as that illustrated in FIG. 23A is detected.

In step S3004, the camerawork identification unit 122b determines whether the horizontal component of the motion vector determined in step S2801 is the right direction for the partial regions set in the left half of the image (the partial regions 3100 and 3101, in the example in FIG. 31). The camerawork identification unit 122b executes step S3005 if so, and executes step S3007 if not.

In step S3005, the camerawork identification unit 122b determines whether the horizontal component of the motion vector determined in step S2801 is the left direction for the partial regions set in the right half of the image (the partial regions 3102 and 3103, in the example in FIG. 31). The camerawork identification unit 122b executes step S3006 if so, and executes step S3007 if not.

In step S3006, the camerawork identification unit 122b determines that the movement direction of the camerawork is backward. A motion vector in the direction opposite from that in FIG. 23A is detected when taking a leading shot of a subject retreating in a diagonal-downward direction. Even in this case, according to the present embodiment, the movement direction of the camera can be correctly determined as being backward.

In step S3007, the camerawork identification unit 122b determines whether the vertical component of the motion vector determined in step S2801 is the upward direction for the partial regions set in the upper half of the image (the partial regions 3100 and 3102, in the example in FIG. 31). The camerawork identification unit 122b executes step S3008 if so, and executes step S3009 if not.

In step S3008, the camerawork identification unit 122b determines whether the vertical component of the motion vector determined in step S2801 is the downward direction for the partial regions set in the lower half of the image (the partial regions 3101 and 3103, in the example in FIG. 31). The camerawork identification unit 122b executes step S3003 if so, and executes step S3011 if not.

In this manner, even if the vertical component of the motion vector is determined to be upward in the upper half of the image and downward in the lower half, the movement direction of the camera is correctly determined to be forward.

In step S3009, the camerawork identification unit 122b determines whether the vertical component of the motion vector determined in step S2801 is the downward direction for the partial regions set in the upper half of the image (the partial regions 3100 and 3102, in the example in FIG. 31). The camerawork identification unit 122b executes step S3010 if so, and executes step S3011 if not.

In step S3010, the camerawork identification unit 122b determines whether the vertical component of the motion vector determined in step S2801 is the upward direction for the partial regions set in the lower half of the image (the partial regions 3101 and 3103, in the example in FIG. 31). The camerawork identification unit 122b executes step S3006 if so, and executes step S3011 if not.

In this manner, even if the vertical component of the motion vector is determined to be downward in the upper half of the image and upward in the lower half, the movement direction of the camera is correctly determined to be backward.

In step S3011, the camerawork identification unit 122b determines that the movement direction of the camera is undetermined. This corresponds to when the movement direction of the camera cannot be determined from the motion vector alone, such as when the camera is stationary or when a subject moving through the entire image is detected. In this case, the camerawork can be identified in further detail by determining an output signal or the like of the motion detection unit 123.

### OTHER EMBODIMENTS

The foregoing embodiments described a configuration in which camerawork is identified when capturing (recording) a moving image with a digital camera. However, the identification of the camerawork need not be executed during capturing or recording. For example, if information about the movement of the digital camera that captured (recorded) the moving image data (e.g., an output signal from the motion detection unit 123) is recorded in association with the moving image data, the camerawork performed in the recorded moving image data can be identified as well.

In the foregoing embodiments, the angular velocity about three axes, namely the yaw axis, the pitch axis, and the roll axis, was used as the information about the movement of the digital camera. However, the angular velocity about the roll axis need not be used. The operations performed in the first embodiment do not change even if the angular velocity about the roll axis is not used. Whether the gimbal control amount or the rotation angle for the pitch axis is greater than the gimbal control amount or rotation angle for the yaw axis may be determined in step S2201 of the second embodiment.

In addition, the foregoing embodiments described a configuration for identifying a single item of camerawork based on motion vectors, information about the movement of the digital camera, and the like. However, the configuration may be such that a plurality of items of camerawork are identified and a confidence is output for each. For example, the confidence can be calculated based on the proportion of candidates for movement directions in the first embodiment; the angle histogram of the motion vectors, the standard deviation of the angles of the motion vectors in the partial region in the third embodiment; and the like. In an application that obtains the identified camerawork, control, display, and the like can be changed according to the calculated confidence, in conjunction with the camerawork identification result.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-074511, filed May 1, 2024, and Japanese Patent Application No. 2024-198333, filed Nov. 13, 2024, which are hereby incorporated by reference herein in their entirety.

What is claimed is:

1. An image processing apparatus comprising:
one or more processors that execute a program stored in a memory and thereby function as:
a detection unit configured to detect one or more motion vectors from a moving image;
a first obtainment unit configured to obtain information about a subject region detected in the moving image;
a second obtainment unit configured to obtain information about movement of an image capture apparatus occurring when the moving image was captured; and
an identification unit configured to, based on at least two of the one or more motion vectors, the information about the subject region, and the information about movement, identify camerawork of the image capture apparatus performed when the moving image was captured, from among a predetermined plurality of types of camerawork.

2. The image processing apparatus according to claim 1,
wherein the one or more processors further function as a determination unit configured to determine a moving direction of the image capture apparatus based on the one or more motion vectors,
wherein the detection unit detects a motion vector for each of a plurality of regions obtained by dividing an entire frame of the moving image,
wherein the determination unit takes one of the motion vectors detected by the detection unit as a reference motion vector, obtains a movement direction candidate for each of a plurality of different ones of the reference motion vector, and determines a movement direction candidate having a highest frequency as the movement direction of the image capture apparatus, and
wherein the identification unit identifies the camerawork based on the movement direction determined by the determination unit and one or both of the information about the subject region and the information about movement.

3. The image processing apparatus according to claim 2,
wherein the determination unit obtains the movement direction candidate based on combinations of (i) a position, in a frame, of an intersection between a direction of the reference motion vector and a direction of another motion vector and (ii) a sign of the reference motion vector.

4. The image processing apparatus according to claim 3,
wherein the determination unit uses, from among the positions, position(s) included in a plurality of regions set in advance for the frame to obtain the movement direction candidate.

5. The image processing apparatus according to claim 4,
wherein the plurality of regions are set in advance in a center of the frame and in upper, lower, left, and right peripheral regions of the frame.

6. The image processing apparatus according to claim 1,
wherein the information about movement includes an angular velocity about a pitch axis and a yaw axis of the image capture apparatus.

7. The image processing apparatus according to claim 6,
wherein in a case where the movement direction is right or left, the identification unit identifies circling and panning, and directions thereof, as the camerawork, based on
a magnitude and a sign of the angular velocity about the yaw axis,
a position of the subject region, and
a magnitude of a motion vector of the subject region.

8. The image processing apparatus according to claim 6,
wherein in a case where the movement direction is right or left, the identification unit identifies dolly movement and a direction thereof as the camerawork, based on
a magnitude of the angular velocity about the yaw axis, and
the movement direction.

9. The image processing apparatus according to claim 6,
wherein in a case where the image capture apparatus uses a gimbal mechanism,
even if the movement direction is right or left, if an amplitude of a control amount of the gimbal mechanism or a rotation angle of the gimbal mechanism with respect to the pitch axis is greater than an amplitude of a control amount of the gimbal mechanism or a rotation angle of the gimbal mechanism with respect to the yaw axis, the identification unit identifies push-in, pull-out, following, and leading as the camerawork, based on
a position of the subject region,
a change in a size of the subject region, and
the movement direction.

10. The image processing apparatus according to claim 6,
wherein in a case where the movement direction is up or down, the identification unit identifies tilt and elevation, and directions thereof, as the camerawork, based on
a magnitude of the angular velocity about the pitch axis, and
whether the movement direction is right or left.

11. The image processing apparatus according to claim 10,
wherein in a case where the image capture apparatus uses a gimbal mechanism,
even if the movement direction is up or down, if a frequency component greater than or equal to a frequency threshold is detected as a main frequency component of a control amount of the gimbal mechanism or a rotation angle of the gimbal mechanism with respect to the pitch axis, the identification unit identifies push-in, pull-out, following, and leading as the camerawork, based on
a position of the subject region,
a change in a size of the subject region, and
the movement direction.

12. The image processing apparatus according to claim 6,
wherein in a case where the movement direction is forward or backward, the identification unit identifies push-in, pull-out, following, and leading as the camerawork, based on
a position of the subject region,
a change in a size of the subject region, and
the movement direction.

13. The image processing apparatus according to claim 1,
wherein the one or more processors further function as a determination unit configured to determine a moving direction of the image capture apparatus based on the one or more motion vectors,
wherein the detection unit detects a motion vector for each of a plurality of regions obtained by dividing a frame of the moving image,
wherein in a case where a ratio of a maximum frequency to a total frequency of an angular distribution of the motion vectors detected by the detection unit exceeds a threshold, the determination unit identifies the movement direction of the image capture apparatus based on an angle corresponding to the maximum frequency, and
wherein the identification unit identifies the camerawork based on the movement direction determined by the determination unit and one or both of the information about the subject region and the information about movement.

14. The image processing apparatus according to claim 13,
wherein the determination unit determines the movement direction of the image capture apparatus as up, down, left, or right based on the angle corresponding to the maximum frequency.

15. The image processing apparatus according to claim 13,
wherein in a case where the ratio is not greater than the threshold, the determination unit:
determines a direction of a motion vector for each of a plurality of partial regions set for a frame of the moving image, according to a horizontal direction component and a vertical direction component; and
determines the movement direction of the image capture apparatus as forward or backward based on a relationship between a position of each of the plurality of partial regions and the direction of the motion vector identified.

16. The image processing apparatus according to claim 15,
wherein the determination unit determines the movement direction of the image capture apparatus is forward in a case where
(i) among the plurality of partial regions, the horizontal direction component of the motion vector determined for a partial region set for a left half of the frame is leftward and the horizontal direction component of the motion vector determined for a partial region set for a right half of the frame is rightward, or
(ii) among the plurality of partial regions, the vertical direction component of the motion vector determined for a partial region set for an upper half of the frame is upward and the vertical direction component of the motion vector determined for a partial region set for a lower half of the frame is downward.

17. The image processing apparatus according to claim 15,
wherein the determination unit determines the movement direction of the image capture apparatus is backward in a case where
(i) among the plurality of partial regions, the horizontal direction component of the motion vector determined for a partial region set for a left half of the frame is rightward and the horizontal direction component of the motion vector determined for a partial region set for a right half of the frame is leftward, or
(ii) among the plurality of partial regions, the vertical direction component of the motion vector determined for a partial region set for an upper half of the frame is downward and the vertical direction component of the motion vector determined for a partial region set for a lower half of the frame is upward.

18. The image processing apparatus according to claim 15,
wherein, of the plurality of partial regions, the determination unit does not use a partial region for which a standard deviation of an angle of the motion vector is greater than or equal to a predetermined value in determining the movement direction of the image capture apparatus.

19. The image processing apparatus according to claim 1,
wherein, instead of identifying the camerawork of the image capture apparatus, the identification unit outputs a confidence for each of the plurality of types of camerawork.

20. An image capture apparatus comprising:
an image capture circuitry that outputs a moving image;
an image processing apparatus that identifies camerawork of the image capture apparatus performed when the moving image was captured; and
a recording circuitry that records a type of the camerawork identified by the identification unit in association with the moving image,
wherein the image processing apparatus comprises:
one or more processors that execute a program stored in a memory and thereby function as:
a detection unit configured to detect one or more motion vectors from the moving image;
a first obtainment unit configured to obtain information about a subject region detected in the moving image;
a second obtainment unit configured to obtain information about movement of the image capture apparatus occurring when the moving image was captured; and
an identification unit configured to, based on at least two of the one or more motion vectors, the information about the subject region, and the information about movement, identify the camerawork of the image capture apparatus performed when the moving image was captured, from among a predetermined plurality of types of camerawork.

21. An image processing method comprising:
detecting a motion vector from a moving image;
obtaining information about a subject region detected in the moving image;
obtaining information about movement of an image capture apparatus occurring when the moving image was captured; and
based on at least two of the motion vector, the information about the subject region, and the information about movement, identifying camerawork of the image capture apparatus performed when the moving image was captured, from among a predetermined plurality of types of camerawork.

22. A non-transitory computer-readable medium storing a program for causing a computer to perform an image processing method comprising:
detecting a motion vector from a moving image;
obtaining information about a subject region detected in the moving image;
obtaining information about movement of an image capture apparatus occurring when the moving image was captured; and
based on at least two of the motion vector, the information about the subject region, and the information about movement, identifying camerawork of the image capture apparatus performed when the moving image was captured, from among a predetermined plurality of types of camerawork.
